(19) United States
(12) Patent Application Publication
(10) Pub. No.: US 2026/0061465 A1
(43) Pub. Date: Mar. 5, 2026

(54) SUBSTRATE PROCESSING APPARATUS AND SUBSTRATE PROCESSING METHOD

(71) Applicant: SCREEN Holdings Co., Ltd., Kyoto (JP)

(72) Inventor: Song ZHANG, Kyoto (JP)

(21) Appl. No.: 19/246,619

(22) Filed: Jun. 23, 2025

(30) Foreign Application Priority Data
Aug. 30, 2024 (JP) 2024-148588

(51) Int. Cl. B08B 7/00; B01D 17/02; B01D 17/04; F16K 31/26; H01L 21/67

(52) U.S. Cl. CPC B08B 7/0014; B01D 17/0202; B01D 17/042; F16K 31/26

(57) ABSTRACT

A substrate processing apparatus: includes a spin chuck; a nozzle to supply a processing liquid to a surface of a substrate; a processing film forming portion to solidify or cure the processing liquid to form a processing film; a peeling portion to peel off the processing film; a drain piping to discharge a waste liquid; a film piece discharge portion to guide film pieces of the processing film peeled off and discharged from the surface of the substrate to the drain piping using a first liquid; a second liquid supplying portion to supply a second liquid to the drain piping; a separator to separate the first liquid and the second liquid; a first liquid storage; and a second liquid storage. The processing film is soluble in one of the first liquid and the second liquid, and is insoluble or poorly soluble in the other of them.

### CROSS REFERENCE TO RELATED APPLICATIONS

This application claims the benefit of priority to Japanese Patent Application No. 2024-148588 filed on Aug. 30, 2024 and the entire contents of this application are hereby incorporated herein by reference.

### BACKGROUND OF THE INVENTION

### 1. Field of the Invention

The present invention relates to a substrate processing apparatus and a substrate processing method. Examples of substrates to be processed include semiconductor wafers, substrates for liquid crystal display devices, substrates for flat panel displays (FPDs), such as organic electroluminescence (EL) display devices, etc., substrates for optical disks, substrates for magnetic disks, substrates for magneto-optical disks, substrates for photomasks, ceramic substrates, substrates for solar cells, and other substrates.

### 2. Description of the Related Art

US 2019/371599 A1 discloses a substrate processing apparatus and a substrate processing method capable of removing a removal object present on a substrate. A processing liquid is supplied to a surface of the substrate, and the processing liquid is solidified or cured to form a processing film. The processing film holds a removal object on the substrate. By supplying a peeling liquid to the substrate, the processing film holding the removal object is peeled off and removed from the substrate. Accordingly, the removal object on the substrate can be removed.

### SUMMARY OF THE INVENTION

The processing film peeled off from the substrate by the peeling liquid becomes film pieces or film fragments, which are discharged through a drain piping together with the peeling liquid. At this time, there is a risk that the film pieces cause clogging of the drain piping.

If a dissolving liquid capable of dissolving the processing film is allowed to flow into the drain piping, the film pieces can be dissolved and reduced, so that the risk of pipe clogging can be reduced. However, the peeling liquid and the dissolving liquid are mixed in the drain piping and cannot be reused. For example, when a mixed liquid of the peeling liquid and the dissolving liquid is used in a step of peeling off the processing film, the processing film is dissolved by the dissolving liquid. It is likely that the removal object is released from the processing film and reattaches to the surface of the substrate. Therefore, it is difficult to reuse the peeling liquid and the dissolving liquid if mixed in the drain piping. Consequently, the consumption of the peeling liquid and the dissolving liquid increases, resulting in a large environmental load and high running costs.

Therefore, a preferred embodiment of the present invention provides a substrate processing apparatus and a substrate processing method, each of which is capable of reducing the risk of clogging a drain piping, reducing the amount of liquid consumed, and contributing to reduction in environmental load and running costs saving.

One preferred embodiment of the present invention provides a substrate processing apparatus including: a spin chuck to hold a substrate; a processing liquid nozzle to supply a processing liquid containing a solute and a solvent to a surface of the substrate held by the spin chuck; a processing film forming portion including a spin motor to rotate the spin chuck, configured to solidify or cure the processing liquid to form a processing film on the surface of the substrate; a peeling portion including a fluid nozzle to supply a fluid toward the surface of the substrate held by the spin chuck, configured to peel off the processing film from the surface of the substrate; and a drain piping to discharge a waste liquid discharged from the substrate held by the spin chuck. The substrate processing apparatus includes: a film piece discharge portion including a guard disposed around the spin chuck, configured to guide film pieces or film fragments of the processing film that have been peeled off from the surface of the substrate by the peeling portion and discharged from the surface of the substrate to the drain piping using a first liquid; a second liquid supplying portion including a second liquid nozzle to eject a second liquid different from the first liquid, configured to supply the second liquid to the drain piping; a separator provided in the drain piping, configured to separate the first liquid and the second liquid; a first liquid storage to receive the first liquid separated by the separator; and a second liquid storage to receive the second liquid separated by the separator. The processing film is soluble in one of the first liquid and the second liquid, and is insoluble or poorly soluble (hardly soluble) in the other of the first liquid and the second liquid.

In a preferred embodiment, the second liquid nozzle supplies the second liquid to the substrate in the spin chuck.

In a preferred embodiment, the processing film is insoluble or poorly soluble in the first liquid and soluble in the second liquid. The fluid nozzle includes a peeling liquid nozzle to eject a peeling liquid as the fluid. The peeling portion is configured to peel off the processing film from the surface of the substrate by supplying the first liquid as the peeling liquid from the peeling liquid nozzle to the surface of the substrate in the spin chuck. The guard of the film piece discharge portion is configured to guide the peeling liquid (the first liquid) discharged from the surface of the substrate together with the film pieces of the processing film to the drain piping.

In a preferred embodiment, the second liquid nozzle includes a residue removing liquid nozzle to eject a residue removing liquid as the second liquid. The second liquid supplying portion includes a residue removing processing portion configured to supply the residue removing liquid to the surface of the substrate from the residue removing liquid nozzle in the spin chuck, and dissolve and remove a residue of the processing film remaining on the surface of the substrate from which the processing film has been peeled off by the peeling portion. The residue removing liquid (the second liquid) discharged from the surface of the substrate is guided to the drain piping.

In a preferred embodiment, the processing film is soluble in the first liquid and insoluble or poorly soluble in the second liquid. The film piece discharge portion includes a residue removing liquid nozzle to supply the first liquid as a residue removing liquid to the surface of the substrate in the spin chuck and dissolve a residue of the processing film remaining on the surface of the substrate from which the processing film has been peeled off by the peeling portion, and is configured to guide the residue removing liquid (the first liquid) discharged from the surface of the substrate together with the film pieces of the processing film to the drain piping. The second liquid nozzle includes a replacement liquid nozzle to eject a replacement liquid as the second liquid. The second liquid supplying portion includes a replacement processing portion configured to supply the replacement liquid from the replacement liquid nozzle to the surface of the substrate in the spin chuck and replace the residue removing liquid remaining on the surface of the substrate with the replacement liquid, and the second liquid discharged from the surface of the substrate is guided to the drain piping.

In a preferred embodiment, the fluid nozzle includes a peeling gas nozzle to eject a peeling gas as the fluid. The peeling portion is configured to peel off the processing film from the surface of the substrate by blowing the peeling gas from the peeling gas nozzle toward the surface of the substrate in the spin chuck.

In a preferred embodiment, the first liquid and the second liquid are incompatible with each other and have different densities. The separator includes: a waste liquid trap tank to store the first liquid and the second liquid to dissolve film pieces of the processing film; a first discharge port to discharge the first liquid from the waste liquid trap tank; and a second discharge port to discharge the second liquid from the waste liquid trap tank. The separator also includes a valve mechanism having a floating body that vertically moves up and down following an interface between the first liquid and the second liquid in the waste liquid trap tank, configured to open one of the first discharge port and the second discharge port and close the other of the first discharge port and the second discharge port by the vertical movement of the floating body.

In a preferred embodiment, the first liquid and the second liquid are incompatible with each other, and have different densities and different melting points. The separator includes: a waste liquid trap tank to store the first liquid and the second liquid to dissolve film pieces of the processing film; a chiller to freeze one of a first liquid layer and a second liquid layer formed by vertically separating the first liquid and the second liquid in the waste liquid trap tank to transition to a solid phase and maintains the other of the first liquid layer and the second liquid layer in a liquid phase; and a liquid phase drain piping to discharge the other of the first liquid layer and the second liquid layer, which is maintained in the liquid phase while the one of the first liquid layer and the second liquid layer is in the solid phase, from the waste liquid trap tank.

In a preferred embodiment, the separator includes an ion exchange resin column to selectively extract the first liquid or the second liquid from a mixed liquid of the first liquid and the second liquid.

In a preferred embodiment, either the first liquid or the second liquid contains water. The separator includes a dehydrator to extract water from a mixed liquid of the first liquid and the second liquid.

In a preferred embodiment, the substrate processing apparatus further includes a waste liquid trap tank, provided in the drain piping, to store the first liquid and the second liquid, and dissolve film pieces of the processing film. A mixed liquid of the first liquid and the second liquid is supplied from the waste liquid trap tank to the separator.

One preferred embodiment of the present invention provides a substrate processing method, including: supplying a processing liquid containing a solute and a solvent to a surface of a substrate in a spin chuck; solidifying or curing the processing liquid in the spin chuck to form a processing film on the surface of the substrate; and peeling off the processing film from the surface of the substrate in the spin chuck. The substrate process method includes: guiding film pieces (film fragments) of the processing film peeled off from the surface of the substrate from the spin chuck to a drain piping using a first liquid and discharging the film pieces; supplying a second liquid different from the first liquid to the drain piping; separating the first liquid and the second liquid by a separator provided in the drain piping; and collecting the first liquid and the second liquid separated by the separator in a first liquid storage and a second liquid storage, respectively. The processing film is soluble in one of the first liquid and the second liquid, and is insoluble or poorly soluble (hardly soluble) in the other of the first liquid and the second liquid.

In a preferred embodiment, the processing film is insoluble or poorly soluble in the first liquid and soluble in the second liquid. The processing film is peeled off from the surface of the substrate by supplying the first liquid as a peeling liquid to the surface of the substrate in the spin chuck. When discharging the film pieces, the peeling liquid (the first liquid) discharged from the surface of the substrate together with the film pieces of the processing film is guided to the drain piping.

In a preferred embodiment, the substrate processing method further includes, when supplying the second liquid, supplying the second liquid as a residue removing liquid to the surface of the substrate in the spin chuck and dissolving and removing a residue of the processing film remaining on the surface of the substrate from which the processing film has been peeled off. The residue removing liquid (the second liquid) discharged from the surface of the substrate is guided to the drain piping.

In a preferred embodiment, the processing film is soluble in the first liquid and insoluble or poorly soluble in the second liquid. The substrate processing method further includes, when discharging the film pieces, supplying the first liquid as a residue removing liquid to the surface of the substrate in the spin chuck and dissolving a residue of the processing film remaining on the surface of the substrate from which the processing film has been peeled off, and the residue removing liquid (the first liquid) discharged together with the film pieces of the processing film from the surface of the substrate is guided to the drain piping. The substrate processing method further includes, when supplying the second liquid, supplying the second liquid to the surface of the substrate in the spin chuck and replacing the residue removing liquid remaining on the surface of the substrate with the second liquid, and the second liquid discharged from the surface of the substrate is guided to the drain piping.

In a preferred embodiment, the substrate processing method further includes, when peeling off the processing film, peeling off the processing film from the surface of the substrate by blowing gas toward the surface of the substrate in the spin chuck.

In a preferred embodiment, the first liquid and the second liquid are incompatible with each other and have different densities. The separator includes: a waste liquid trap tank to store the first liquid and the second liquid to dissolve film pieces of the processing film; a first discharge port to discharge the first liquid from the waste liquid trap tank; a second discharge port to discharge the second liquid from the waste liquid trap tank; and a valve mechanism having a floating body that vertically moves up and down following an interface between the first liquid and the second liquid in the waste liquid trap tank, configured to open one of the first discharge port and the second discharge port and close the other of the first discharge port and the second discharge port by the vertical movement of the floating body. The substrate processing method further includes, when separating the first liquid and the second liquid: dissolving film pieces of the processing film in the waste liquid trap tank; opening the first discharge port by the valve mechanism to discharge the first liquid from the waste liquid trap tank; and opening the second discharge port by the valve mechanism to discharge the second liquid from the waste liquid trap tank.

In a preferred embodiment, the first liquid and the second liquid are incompatible with each other, and have different densities and different melting points. The separator includes: a waste liquid trap tank to store the first liquid and the second liquid to dissolve film pieces of the processing film; and a chiller to freeze one of a first liquid layer and a second liquid layer formed by vertically separating the first liquid and the second liquid in the waste liquid trap tank to transition to a solid phase and to maintain the other of the first liquid layer and the second liquid layer in a liquid phase. The substrate processing method further includes, when separating the first liquid and the second liquid: dissolving film pieces of the processing film in the waste liquid trap tank; freezing one of the first liquid layer and the second liquid layer by the chiller to transition to the solid phase and maintaining the other of the first liquid layer and the second liquid layer in the liquid phase; discharging the other of the first liquid layer and the second liquid layer, which is maintained in the liquid phase while the one of the first liquid layer and the second liquid layer is in the solid phase, from the waste liquid trap tank; and discharging the other of the first liquid layer and the second liquid layer, then melting the one of the first liquid layer and the second liquid layer to transition to a liquid phase; and discharging the one of the first liquid layer and the second liquid layer that has transitioned to the liquid phase from the waste liquid trap tank after the melting thereof.

In a preferred embodiment, the separator includes an ion exchange resin column to selectively extract the first liquid or the second liquid from a mixed liquid of the first liquid and the second liquid.

In a preferred embodiment, either the first liquid or the second liquid contains water. The separator includes a dehydrator to extract water from a mixed liquid of the first liquid and the second liquid.

In a preferred embodiment, the substrate processing method further includes: storing the first liquid and the second liquid in a waste liquid trap tank provided in the drain piping so as to dissolve film pieces of the processing film. A mixed liquid of the first liquid and the second liquid is supplied from the waste liquid trap tank to the separator.

The aforementioned or other objects, features and effects of the present invention will be clarified by the description of preferred embodiments to be described below with reference to accompanying drawings.

### BRIEF DESCRIPTION OF THE DRAWINGS

FIG. 1 is a schematic plan view of a substrate processing apparatus according to a preferred embodiment of the present invention.

FIG. 2 is a schematic diagram for describing a configuration example of a processing unit.

FIG. 3 is a block diagram illustrating an electrical configuration of a main portion of the substrate processing apparatus.

FIG. 4 is a flowchart for describing an example of a substrate processing method.

FIG. 5A shows a state of a processing liquid supplying step.

FIG. 5B shows a state of a processing film forming step.

FIG. 5C shows a state of a peeling step.

FIG. 5D shows a state of an elimination step.

FIG. 5E shows a state of a residue removing step.

FIG. 5F shows a state of a rinsing step.

FIG. 5G shows a state of a drying step.

FIGS. 6A, 6B, and 6C illustrate a first configuration example of a drainage system.

FIGS. 7A and 7B illustrate a second configuration example of the drainage system.

FIGS. 8A and 8B illustrate a third configuration example of the drainage system.

FIG. 9 illustrates a fourth configuration example of the drainage system.

FIG. 10 illustrates a configuration example of a processing unit according to another preferred embodiment of the present invention.

FIG. 11 is a flowchart for describing an example of a substrate processing method executed by the processing unit.

FIG. 12A shows a state of a processing liquid supplying step.

FIG. 12B shows a state of a processing film forming step.

FIG. 12C shows a state of a peeling step.

FIG. 12D shows a state of a residue removing step.

FIG. 12E shows a state of a replacement step.

FIG. 12F shows a state of a drying step.

FIGS. 13A and 13B are diagrams for describing the peeling of a processing film by peeling gas.

FIG. 14 illustrates a configuration example of a drainage system.

### DETAILED DESCRIPTION OF THE PREFERRED EMBODIMENTS

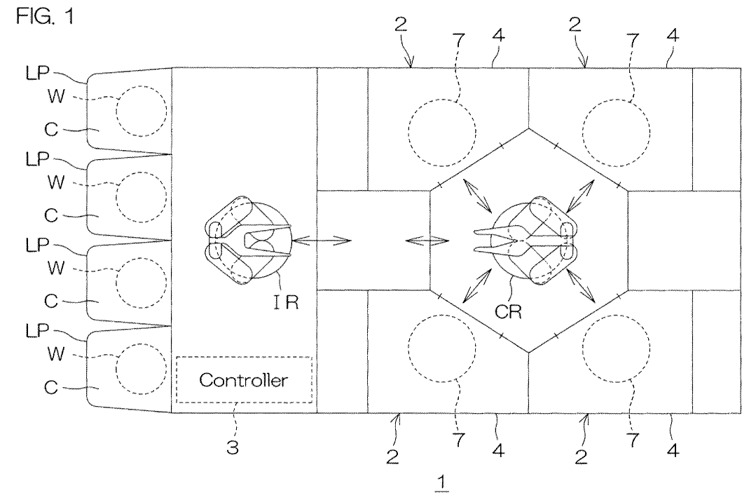

FIG. 1 is a schematic plan view illustrating a layout of a substrate processing apparatus 1 according to a preferred embodiment of the present invention.

The substrate processing apparatus 1 is a single substrate processing type apparatus that processes a substrate W, such as a silicon wafer, etc., one at a time. In this preferred embodiment, the substrate W is a disk-shaped substrate. Typically, a fine uneven pattern is formed on a surface (principal surface) of the substrate W.

The substrate processing apparatus 1 includes a plurality of processing units 2 for processing substrates W with fluids, load ports LP on which are placed carriers C that house a plurality of the substrates W to be processed by the processing units 2, transfer robots IR and CR that transfer the substrates W between the load ports LP and the processing units 2, and a controller 3 that controls the substrate processing apparatus 1.

The transfer robot IR is an indexer robot that transfers the substrate W between the carrier C and the transfer robot CR. The transfer robot CR is a main transfer robot that transfers the substrates W between the transfer robot IR and the processing units 2. The plurality of processing units 2 have, for example, the same arrangement.

Each processing unit 2 includes a chamber 4 and a processing cup 7 disposed inside the chamber 4 and executes processing for the substrate W inside the processing cup 7. In the chamber 4, an entrance/exit (not illustrated) for carrying in the substrate W and carrying out the substrate W by the transfer robot CR is formed. The chamber 4 is provided with a shutter unit (not illustrated) that opens and closes the entrance/exit.

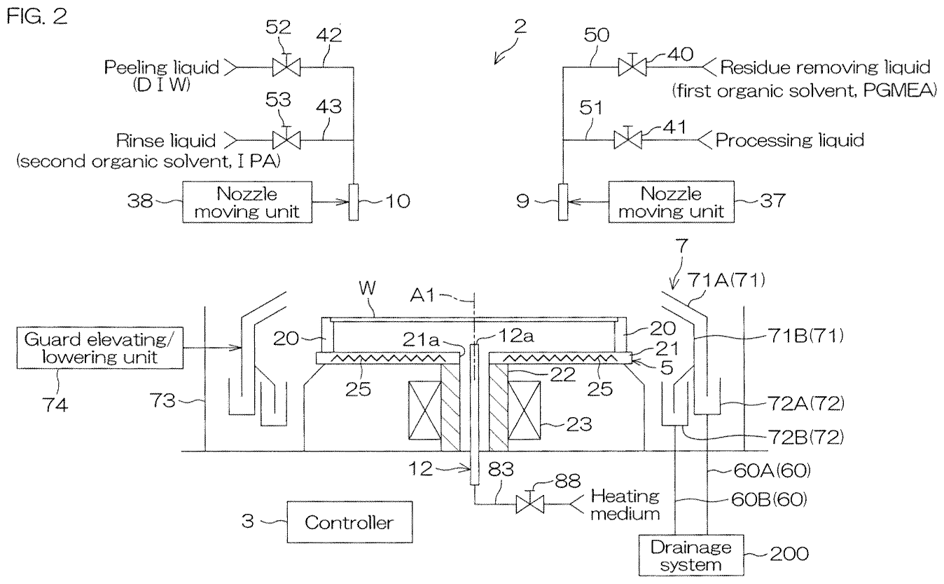

FIG. 2 is a schematic diagram for describing a configuration example of the processing unit 2.

The processing unit 2 includes a spin chuck 5, a processing cup 7, a first moving nozzle 9, a second moving nozzle 10, and a lower surface nozzle 12.

The spin chuck 5 rotates the substrate W around a rotational axis A1 while horizontally holding the substrate W. The rotational axis A1 is a vertical rectilinear line that passes through a central portion of the substrate W. The spin chuck 5 includes a plurality of chuck pins 20, a spin base 21, a rotating shaft 22 and a spin motor 23. The spin chuck 5 provides a substrate processing portion that processes the substrate W.

The spin base 21 has a disk shape oriented along a horizontal direction. On an upper surface of the spin base 21, the plurality of chuck pins 20 that grip a peripheral edge of the substrate W are disposed at intervals in a circumferential direction of the spin base 21. The spin base 21 and the plurality of chuck pins 20 constitute a substrate holding unit that holds the substrate W horizontally. The substrate holding unit is also referred to as a substrate holder.

The rotating shaft 22 extends in a vertical direction along the rotational axis A1. An upper end portion of the rotating shaft 22 is coupled to a lower surface center of the spin base 21. The spin motor 23 applies a rotating force to the rotating shaft 22. The spin base 21 is rotated by the rotating shaft 22 being rotated by the spin motor 23. The substrate W is thereby rotated around the rotational axis A1. The spin motor 23 is one example of a substrate rotating unit that rotates the substrate W around the rotational axis A1.

The processing cup 7 is housed in the chamber 4 (see FIG. 1). The processing cup 7 includes a plurality of guards 71 that receive liquid splashed outside from the substrate W held by the spin chuck 5, a plurality of cups 72 that receive liquid guided downward by the plurality of guards 71, and a circular-cylindrical outer wall member 73 that surrounds the plurality of guards 71 and the plurality of cups 72.

In this preferred embodiment, there is shown an example where two guards 71 (a first guard 71A and a second guard 71B) and two cups 72 (a first cup 72A and a second cup 72B) are provided. Each of the first cup 72A and the second cup 72B has an annular groove shape that is opened upward. The first guard 71A is disposed so as to surround the spin base 21. The second guard 71B is disposed so as to surround the spin base 21 at an inner side in a rotational radius direction of a substrate W relative to the first guard 71A. Each of the first guard 71A and the second guard 71B has a substantially circular cylindrical shape, and an upper end portion of each of the guards 71A and 71B is inclined inward so as to be directed toward the spin base 21.

The first cup 72A is formed integral to the second guard 71B and receives liquid guided downward by the first guard 71A. The second cup 72B receives liquid guided downward by the second guard 71B. A liquid received by the cup 72 is guided to a drainage system 200 through a drain piping 60. The drain piping 60 includes a first drain piping 60A and a second drain piping 60B. A liquid received by the first cup 72A is guided to the drainage system 200 through the first drain piping 60A. A liquid received by the second cup 72B is guided to the drainage system 200 through the second drain piping 60B.

The processing unit 2 includes a guard elevating/lowering unit 74 (guard elevator or lift) that elevates and lowers each of the first guard 71A and the second guard 71B separately. The guard elevating/lowering unit 74 elevates and lowers the first guard 71A between a lower position and an upper position. The guard elevating/lowering unit 74 elevates and lowers the second guard 71B between a lower position and an upper position. When the first guard 71A and the second guard 71B are both positioned at the upper position, liquid splashing from the substrate W is received by the second guard 71B. When the second guard 71B is located at the lower position and the first guard 71A is located at the upper position, the liquid splashing from the substrate W is received by the first guard 71A.

The guard elevating/lowering unit 74 includes, for example, a first ball-screw mechanism (not shown) coupled to the first guard 71A, a first motor (not shown) that applies a driving force to the first ball-screw mechanism, a second ball-screw mechanism (not shown) coupled to the second guard 71B, and a second motor (not shown) that applies a driving force to the second ball-screw mechanism. The guard elevating/lowering unit 74 is also referred to as a guard lifter.

The first moving nozzle 9 is one example of a processing liquid nozzle (processing liquid supplying unit) that supplies (ejects) a processing liquid toward the upper surface of the substrate W held by the spin chuck 5. The first moving nozzle 9 is also one example of a residue removing liquid nozzle (residue removing liquid supplying unit, residue removing processing portion) that supplies (ejects) a first organic solvent as a residue removing liquid toward the upper surface of the substrate W held by the spin chuck 5. Of course, the processing liquid supplying unit and the residue removing liquid supplying unit may include individual nozzles.

The first moving nozzle 9 is moved in a horizontal direction and in a vertical direction by a first nozzle moving unit 37. The first moving nozzle 9 is capable of moving between a center position and a home position (retreat position). When positioned at the center position, the first moving nozzle 9 faces a rotation center of the upper surface of the substrate W. The rotation center of the upper surface of the substrate W is a position of intersection of the rotational axis A1 with the upper surface of the substrate W.

When positioned at the home position, the first moving nozzle 9 does not face the upper surface of the substrate W and is positioned outside the processing cup 7 in plan view. By moving in the vertical direction, the first moving nozzle 9 can move close to the upper surface of the substrate W and retreat upward from the upper surface of the substrate W.

The first nozzle moving unit 37 includes, for example, a pivoting shaft (not shown) oriented along the vertical direction, an arm (not shown) that is coupled to the pivoting shaft and the first moving nozzle 9 and extends horizontally, and a pivoting shaft driving unit (not shown) that elevates, lowers, and pivots the pivoting shaft.

The pivoting shaft driving unit pivots the pivoting shaft around a vertical pivoting axis, thereby swinging the arm. Further, the pivoting shaft driving unit elevates and lowers the pivoting shaft along the vertical direction, thereby moving the arm up and down. The first moving nozzle 9 is fixed to the arm. The first moving nozzle 9 moves in the horizontal direction and in the vertical direction in accordance with the swinging and elevation/lowering of the arm.

The first moving nozzle 9 is connected to a processing liquid piping 41 that guides a processing liquid. When a processing liquid valve 51 interposed in the processing liquid piping 41 is opened, the processing liquid is ejected continuously downward from the first moving nozzle 9. The first moving nozzle 9 is further connected to a residue removing liquid piping 40. When the residue removing liquid valve 50 interposed in the residue removing liquid piping 40 is opened, the first organic solvent as the residue removing liquid is continuously ejected downward from the first moving nozzle 9.

The processing liquid ejected from the first moving nozzle 9 contains a solute and a solvent. The processing liquid undergoes solidification or curing by at least a portion of the solvent volatilizing (evaporating). The processing liquid undergoes solidification or curing on the substrate W to form a processing film that holds a removal object (foreign matter), such as particles, etc., present on the substrate W. The solute typically includes a polymer. Thus, the processing film is typically a polymer film. The solvent typically includes an organic solvent.

Here, “solidification” refers, for example, to hardening of the solute due to forces acting between molecules or between atoms, etc., in association with the volatilization (evaporation) of the solvent. “Curing” refers, for example, to hardening of the solute due to a chemical change such as polymerization, crosslinking, etc. “Solidification or curing” thus expresses “hardening” of the solute due to any of various causes.

The solute in the processing liquid ejected from the first moving nozzle 9 may contain, for example, a first component and a second component. For example, the amount (content) of the first component contained in the processing liquid is smaller than the amount (content) of the second component contained in the processing liquid. The first component is a high solubility component having relatively high solubility in a peeling liquid described later (that is, soluble in a peeling liquid). The second component is a low solubility component having relatively low solubility in a peeling liquid described later (for example, insoluble or poorly soluble in a peeling liquid).

The first component and the second component are, for example, synthetic resins having different properties from each other. It suffices that the solvent contained in the processing liquid ejected from the first moving nozzle 9 is a liquid that dissolves the first component and the second component.

Examples of the synthetic resin used as the solute include acrylic resins, phenol resins, epoxy resins, melamine resins, urea resins, unsaturated polyester resins, alkyd resins, polyurethane, polyimide, polyethylene, polypropylene, polyvinylchloride, polystyrene, polyvinyl acetate, polytetrafluoroethylene, acrylonitrile butadiene styrene resins, acrylonitrile styrene resins, polyamide, polyacetal, polycarbonate, polyvinyl alcohol, modified polyphenylene ether, polybutylene terephthalate, polyethylene terephthalate, polyphenylene sulfide, polysulfone, polyether ether ketone, and polyamide-imide.

Examples of the solvent for dissolving the synthetic resin include IPA, propylene glycol monoethyl ether (PGEE), propylene glycol monomethyl ether (PGME), propylene glycol monomethyl ether acetate (PGMEA), and ethyl lactate (EL).

The first organic solvent as the residue removing liquid is an organic solvent capable of dissolving the processing film formed by hardening of the processing liquid, that is, a dissolving liquid. Therefore, the residue removing liquid supplying unit is one example of a dissolving liquid supplying unit. Typically, a solvent of the processing liquid is preferably used as the first organic solvent (residue removing liquid). That is, the processing film is soluble in the residue removing liquid. In this preferred embodiment, the residue removing liquid (dissolving liquid) is one example of the “second liquid.”

The second moving nozzle 10 is one example of a peeling liquid nozzle (peeling liquid supplying unit) that supplies (ejects) a peeling liquid toward the upper surface of the substrate W held by the spin chuck 5, and is one example of a processing film removing unit that peels off and removes a processing film 100 on the substrate W to the outside of the substrate W by supplying the peeling liquid. In this preferred embodiment, the second moving nozzle 10 is also one example of a rinse nozzle (rinse liquid supplying unit) that supplies (ejects) a second organic solvent as a rinse liquid toward the upper surface of the substrate W held by the spin chuck 5. Of course, the peeling liquid supplying unit and the rinse liquid supplying unit may include individual nozzles.

The second moving nozzle 10 is moved in a horizontal direction and in a vertical direction by a second nozzle moving unit 38. The second moving nozzle 10 is capable of moving between a center position and a home position (retreat position).

When positioned at the center position, the second moving nozzle 10 faces a rotation center of the upper surface of the substrate W. When positioned at the home position, the second moving nozzle 10 does not face the upper surface of the substrate W and is positioned outside the processing cup 7 in plan view. By moving in the vertical direction, the second moving nozzle 10 can move close to the upper surface of the substrate W and retreat upward from the upper surface of the substrate W.

The second nozzle moving unit 38 has the same arrangement as the first nozzle moving unit 37. That is, the second nozzle moving unit 38 includes, for example, a pivoting shaft (not shown) oriented along the vertical direction, an arm (not shown) that is coupled to the pivoting shaft and the second moving nozzle 10 and extends horizontally, and a pivoting shaft driving unit (not shown) that elevates, lowers, and pivots the pivoting shaft.

The second moving nozzle 10 is connected to a peeling liquid piping 42 that guides a peeling liquid to the second moving nozzle 10. When a peeling liquid valve 52 interposed in the peeling liquid piping 42 is opened, a peeling liquid is continuously ejected downward from an ejection port of the second moving nozzle 10.

The second moving nozzle 10 is also connected to a rinse liquid piping 43 that guides the second organic solvent to the second moving nozzle 10 as a rinse liquid. When a rinse liquid valve 53 interposed in the rinse liquid piping 43 is opened, the rinse liquid (second organic solvent) is continuously ejected downward from the ejection port of the second moving nozzle 10.

The peeling liquid is a liquid for peeling off the processing film on the substrate W from the upper surface of the substrate W. As the peeling liquid, a liquid that more easily dissolves the first component contained in the solute of the processing liquid than the second component contained in the solute of the processing liquid is used. In other words, as the peeling liquid, a liquid with which the solubility of the first component in the peeling liquid is higher than the solubility of the second component in the peeling liquid is used. The peeling liquid is preferably a liquid that is capable of peeling off from the surface of the substrate W and discharging to the outside of the substrate W while suppressing dissolution of the processing film formed by hardening of the processing liquid (for example, specifically, dissolving only a small amount of the first component). That is, it is preferable that most of the processing film (that is, the solid of the second component) is substantially insoluble or poorly soluble in the peeling liquid. In such a case, in this specification, there is a description such that the processing film is insoluble or poorly in the peeling liquid. In this preferred embodiment, the peeling liquid is one example of the “first liquid.”

The peeling liquid is, for example, an aqueous peeling liquid. Examples of the aqueous peeling liquid include deionized water (DIW), carbonated water, electrolyzed ion water, hydrogen water, ozone water, hydrochloric acid water having a dilution concentration (for example, about 10 ppm ˜100 ppm), and alkaline aqueous solution. Examples of the alkaline aqueous solution include SC1 solution, ammonia aqueous solution, aqueous solution of quaternary ammonium hydroxide such as TMAH, and choline aqueous solution.

The rinse liquid (second organic solvent) is a liquid capable of replacing the residue removing liquid (first organic solvent) on the substrate W. The second organic solvent is preferably a volatile liquid that is volatilized by rotation (spin drying) of the substrate W. For example, the second organic solvent preferably contains at least one of isopropyl alcohol (IPA), hydrofluoroether (HFE), methanol, ethanol, acetone, and trans-1, 2-dichloroethylene, and may be a mixed liquid of at least one of these and DIW. Typically, the second organic solvent contains IPA, and may be a mixed liquid of IPA and DIW.

The lower surface nozzle 12 is inserted into a penetrating hole 21a that is opened at an upper surface central portion of the spin base 21. An ejection port 12a of the lower surface nozzle 12 is exposed from the upper surface of the spin base 21. The ejection port 12a of the lower surface nozzle 12 faces a central region of a lower surface of the substrate W from below. The central region of the lower surface of the substrate W is a region that includes the rotation center of the substrate W at the lower surface of the substrate W.

A heating medium piping 83 for guiding a heating medium to the lower surface nozzle 12 is connected to the lower surface nozzle 12. When a heating medium valve 88 interposed in the heating medium piping 83 is opened, the heating medium is ejected continuously toward the central region of the lower surface of the substrate W from the lower surface nozzle 12.

The lower surface nozzle 12 is one example of a heating medium supplying unit that supplies the heating medium for heating the substrate W to the substrate W. The lower surface nozzle 12 is also a heating unit that heats the substrate W and thereby heats the processing film on the substrate W. The heating unit is one example of an evaporation promoting unit that promotes evaporation of the solvent in the processing film.

The heating medium ejected from the lower surface nozzle 12 is, for example, high temperature DIW whose temperature is higher than room temperature and lower than the boiling point of the solvent contained in the processing liquid (for example, 60° C. ˜80° C.). The heating medium ejected from the lower surface nozzle 12 is not restricted to the high temperature DIW and may be a high temperature gas, such as a high temperature inert gas or high temperature air, etc., the temperature of which is higher than room temperature and lower than the boiling point of the solvent contained in the processing liquid (for example, 60° C. ˜80° C.).

Instead of heating the substrate W by the heating medium, the substrate W may be heated by a heater 25. For example, the heater 25 may be an electrothermal heater embedded in the spin base 21. Such a heater 25 is one example of the heating unit that heats the processing film on the substrate W, and thus is one example of the evaporation promoting unit that promotes evaporation of the solvent in the processing film.

Although not illustrated, another piping that guides the peeling liquid, residue removing liquid, or the like may be further connected to the lower surface nozzle 12 for cleaning the lower surface of the substrate W, and may be arranged such that these liquids can be ejected from the lower surface nozzle 12 toward the lower surface of the substrate W.

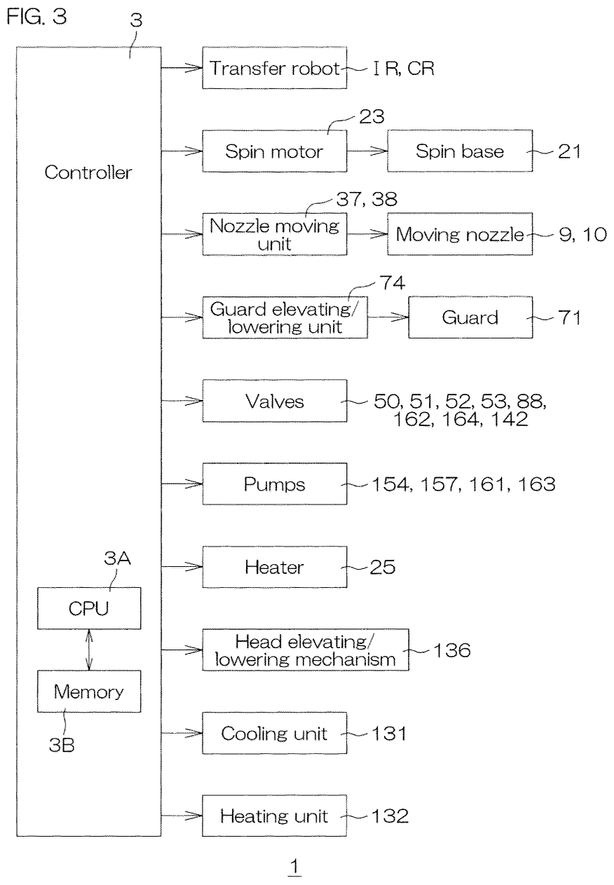

FIG. 3 is a block diagram illustrating the electrical configuration of a main portion of the substrate processing apparatus 1.

The controller 3 includes a microcomputer and controls control objects included in the substrate processing apparatus 1 in accordance with a predetermined control program.

Specifically, the controller 3 includes a processor (CPU) 3A and a memory 3B that stores control programs. The controller 3 is arranged such that various types of control for substrate processing are executed by the processor 3A executing the control programs.

In particular, the controller 3 is programmed to control the transfer robots IR and CR, the spin motor 23, the first nozzle moving unit 37, the second nozzle moving unit 38, the guard elevating/lowering unit 74, the valves 50, 51, 52, 53, and 88, the heater 25, and other elements.

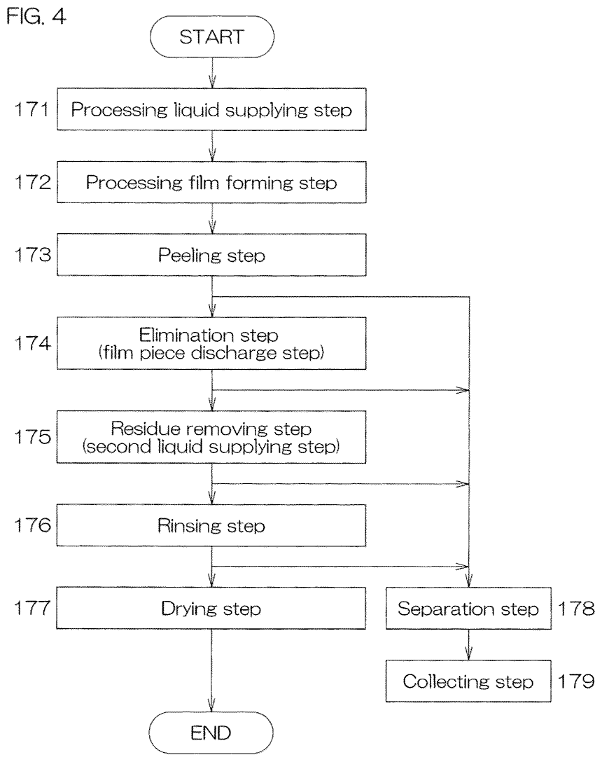

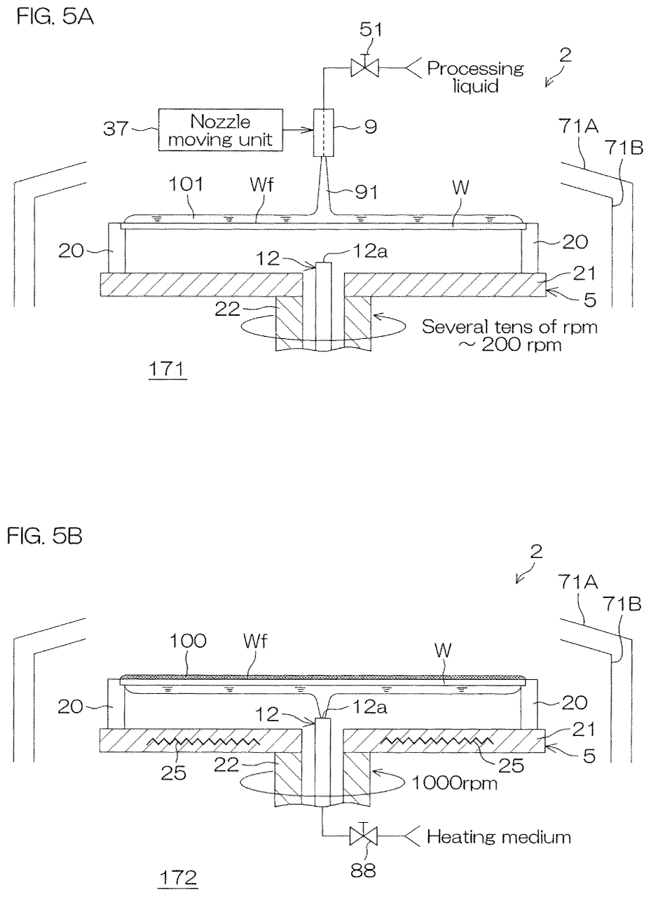

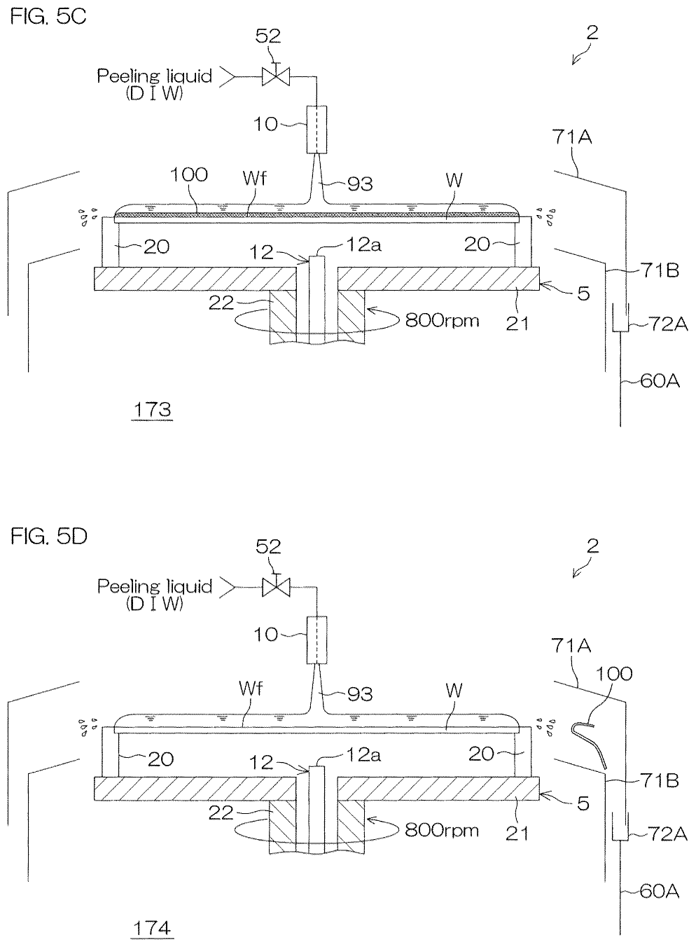

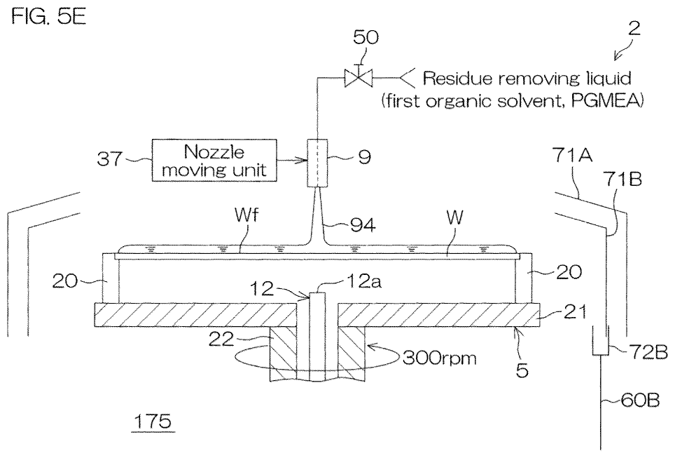

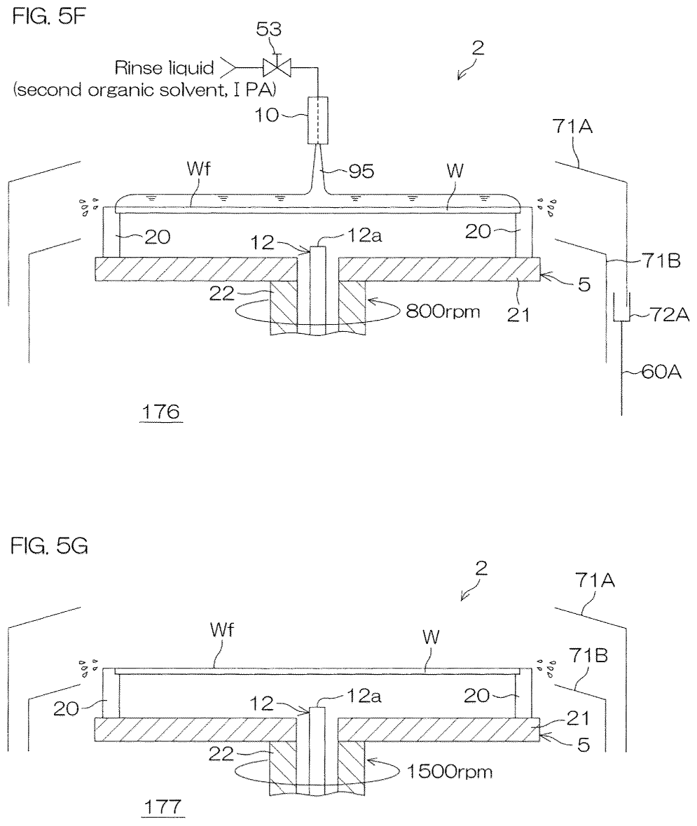

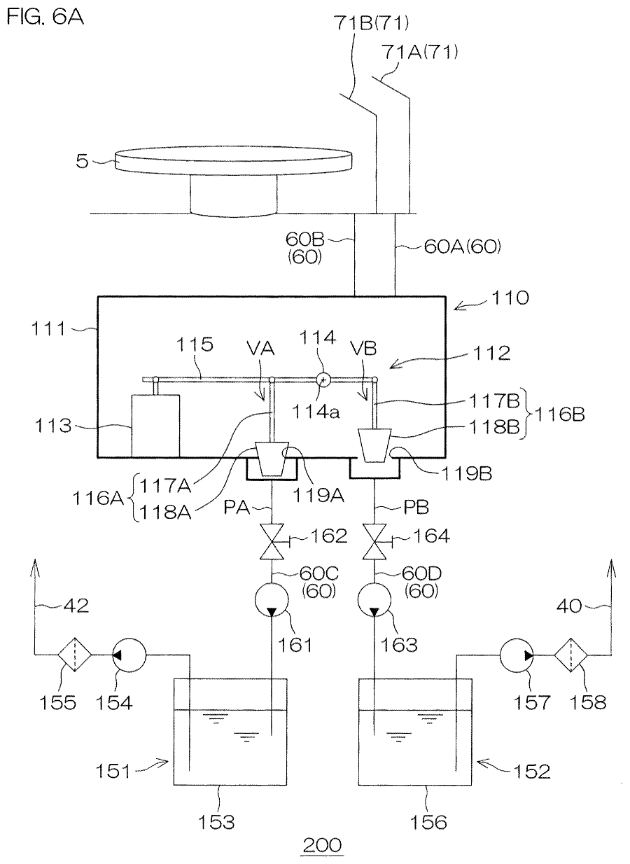

FIG. 4 is a flowchart for describing an example of a substrate processing method executed by the substrate processing apparatus 1, and FIGS. 5A to 5G are diagrams for describing a state of main steps.

In this substrate processing method, a foreign matter removing processing is performed for removing foreign matters (particles) adhering to a principal surface Wf of the substrate W having the principal surface Wf, which is a pattern surface on which an uneven pattern is formed. A typical example of the substrate W is a semiconductor wafer, and in this case, the substrate processing method of this preferred embodiment is mainly executed for the purpose of removing foreign matters from the principal surface of the semiconductor wafer (e.g. silicon wafer) at the front end (FEOL (front-end-of-line), pre-process). The uneven pattern includes, for example, a fine protruding structure formed on the principal surface of the substrate W and a recess (groove) formed between adjacent structures. The structure forming the protrusion may include an insulator film or a conductor film. Also, the structures may be laminated films formed by laminating a plurality of films. The uneven pattern is, for example, a fine pattern having an aspect ratio of 3 or more. The aspect ratio of the uneven pattern is, for example, 10˜50 (for example, 25). A width of the structure constituting the protrusion may be about nm˜45 nm (for example, 20 nm). A distance between the structures, that is, a width of the recess may be about 10 nm˜several μm (for example, 30 nm). A height (pattern height) of the structure constituting the protrusion may be, for example, about 50 nm˜5 μm (for example, 500 nm).

In this example, the processing liquid uses a water-insoluble organic solvent (for example, PGMEA) as a solvent, and therefore the processing film formed by hardening of the processing liquid on the substrate W is insoluble or poorly soluble in DIW. Therefore, as the peeling liquid, an aqueous liquid that does not dissolve the processing film, specifically, DIW is used. In addition to DIW, a liquid (for example, IPA) that hardly dissolves the processing film may be mixed in the peeling liquid. The first organic solvent used as the residue removing liquid (dissolving liquid) is an organic solvent capable of dissolving the processing film, and here, the same organic solvent (for example, PGMEA) as the solvent of the processing liquid is used. That is, the processing film is soluble in the first organic solvent used as the residue removing liquid. For example, IPA can be used as the second organic solvent used as the rinse liquid for replacing the residue removing liquid (first organic solvent) on the substrate W. The second organic solvent may be a liquid that hardly dissolves the processing film on the substrate W. For example, when the solvent of the processing film is PGMEA, the processing film is insoluble or poorly soluble in IPA.

The substrate processing method includes a processing liquid supplying step 171 (see FIG. 5A) of supplying a processing liquid 91 to the principal surface Wf of the substrate W, and a processing film forming step 172 (see FIG. 5B) of solidifying or curing the processing liquid 91 on the principal surface Wf to form a processing film 100 on the principal surface Wf.

In the processing liquid supplying step 171, as shown in FIG. 5A, the processing liquid valve 51 is opened while the substrate W is held and rotated by the spin chuck (rotational speed is, for example, several tens of rpm ˜200 rpm), and the processing liquid 91 is ejected from the first moving nozzle 9 toward the center of the principal surface Wf (upper surface) of the substrate W. The ejected processing liquid 91 receives a centrifugal force on the principal surface Wf of the substrate W, spreads over the entire region of the principal surface Wf, and forms a processing liquid film 101 (liquid film of the processing liquid 91) covering the entire region of the principal surface Wf. That is, the processing liquid film 101 covering the entire region of the principal surface Wf of the substrate W is formed by so-called spin coating. At this time, for example, the guard 71 may be disposed at a position where the second guard 71B receives the liquid shaken off outward from the substrate W.

In the processing film forming step 172, as shown in FIG. 5B, the solvent component of the processing liquid film 101 formed on the principal surface Wf is evaporated, whereby the processing liquid film 101 is solidified or cured to form the processing film 100. Specifically, the processing liquid valve 51 is closed, and the ejection of the processing liquid 91 from the first moving nozzle 9 is stopped. The rotation of the substrate W is continued by the spin motor 23 driving the spin chuck 5, and the rotation may be accelerated as necessary (for example, accelerated to about 1000 rpm). Consequently, the solvent in the processing liquid film 101 is evaporated. In order to promote evaporation of the solvent, heating of the substrate W may be used in combination. The heating of the substrate W can be performed by opening the heating medium valve 88 and ejecting the heating medium from the ejection port 12a of the lower surface nozzle 12 toward the lower surface of the substrate W (the principal surface opposite to the principal surface Wf). Further, the heating of the substrate W can also be performed by energizing the heater provided on the spin base 21. The processing film 100 in a semi-solidified or semi-cured state may be formed by the rotation of the substrate W by the spin chuck 5, and the processing film 100 may be heated through the substrate W to promote the evaporation of the solvent, thereby forming the completely solidified or cured processing film 100. The spin motor 23, the lower surface nozzle 12, the heating medium valve 88, the heater 25, etc., are examples of the “processing film forming portion.”

The substrate processing method includes, after the processing film forming step 172, a peeling step 173 of peeling off the processing film 100 from the principal surface Wf and removing it to the outside of the substrate W (see FIG. 5C). The peeling step 173 includes, for example, a peeling liquid supplying step of supplying a peeling liquid 93 (for example, DIW) for peeling off the processing film 100 from the principal surface Wf toward the principal surface Wf of the substrate W.

In the peeling step 173, as shown in FIG. 5C, the peeling liquid valve 52 is opened, and the peeling liquid 93 is ejected from the second moving nozzle 10 toward the upper surface of the substrate W. The ejected peeling liquid 93 receives a centrifugal force on the substrate W and spreads over the entire region of the principal surface Wf. The peeling liquid 93 reaches the interface between the processing film 100 formed on the principal surface Wf of the substrate W and the substrate W, and reaches the entire region of the principal surface Wf of the substrate W along the interface. Thereby, the processing film 100 can be peeled off from the substrate W. The peeling liquid piping 42, the peeling liquid valve 52, the second moving nozzle (peeling liquid nozzle), etc., are examples of the “peeling portion.” The second moving nozzle 10 (peeling liquid nozzle) is one example of a fluid nozzle.

For example, a paddle step may be performed in which the peeling liquid 93 is ejected from the second moving nozzle 10 to the center of the upper surface of the substrate W while the substrate W is held and rotated (the rotational speed is, for example, 800 rpm) by the spin chuck 5, and after the peeling liquid 93 spreads over the entire region of the principal surface Wf of the substrate W, the rotation of the substrate W is decelerated or stopped to hold a liquid film of the peeling liquid 93 on the substrate W. It is preferable to perform the paddle step for a time sufficient for the peeling liquid 93 to reach the interface between the processing film 100 and the substrate W and for the peeling liquid 93 to spread over the entire region of the interface.

After the processing film 100 is peeled off, an elimination step 174 of eliminating the peeled processing film 100 together with the peeling liquid 93 to the outside of the substrate W by a centrifugal force is performed by rotating the substrate W by the spin chuck 5 (see FIG. 5D). The peeled processing film 100 is typically separated into a plurality of film pieces (film fragments), but the processing film 100 is not necessarily separated, and one film piece may be formed as it is and eliminated to the outside of the substrate W together with the peeling liquid 93.

In the peeling step 173 and the elimination step 174, for example, the guard 71 may be disposed at a position where the first guard 71A receives a liquid shaken off outward from the substrate W. Accordingly, in the peeling step 173, the peeling liquid (DIW) 1) discharged from the substrate W is received by the first guard 71A and guided to the first drain piping 60A. In the elimination step 174, the film pieces of the processing film 100 peeled off from the surface of the substrate W are washed out by the peeling liquid, received by the first guard 71A, and guided to the first drain piping 60A. As described above, the elimination step 174 is one example of a “film piece discharge step” of guiding the film pieces of the processing film to the drain piping by the peeling liquid which is one example of the “first liquid.” The guard 71, etc., is one example of the “film piece discharge portion.”

Before the peeling step 173 or in the middle of the peeling step 173, a path of the peeling liquid for allowing the peeling liquid to reach the interface between the processing film 100 and the substrate W is formed.

For example, a peripheral edge portion removing step of selectively removing a peripheral edge portion (bevel portion) of the processing film 100 may be performed before the peeling step 173. Specifically, the dissolving liquid (for example, the first organic solvent) capable of dissolving the processing film may be supplied toward the peripheral edge portion of the processing film 100, and the peripheral edge portion of the processing film 100 may be selectively dissolved and removed. Accordingly, when the peeling liquid is supplied in the peeling step 173, the peeling liquid can enter the interface between the processing film 100 and the substrate W from the peripheral edge portion of the substrate W.

Furthermore, before the peeling step 173, the dissolving liquid (for example, the first organic solvent) may be ejected toward the processing film 100 in a mist form, for example, to partially dissolve the processing film 100, and a path penetrating the processing film 100 may be formed. Moreover, a notch may be formed in the processing film 100 by supplying high-pressure water from a nozzle before the peeling step 173 or in the middle of the peeling step 173. Additionally, the solute in the processing liquid may contain a small amount of a crack promoting component (the first component described above) that can be dissolved by the peeling liquid. In this case, a path penetrating the processing film 100 to reach the interface with the substrate W is formed in the middle of the peeling step 173, and the peeling liquid reaches the interface between the processing film 100 and the substrate W through the path and spreads along the interface.

The substrate processing method includes, after the elimination step 174, a residue removing step 175 of supplying the first organic solvent (for example, PGMEA) as a residue removing liquid 94 to the principal surface Wf of the substrate W to dissolve the residue of the processing film 100 and removing the residue from the principal surface Wf (see FIG. 5E). The first organic solvent as the residue removing liquid 94 is a dissolving liquid for dissolving the residue of the processing film 100, and is a residue removing liquid for removing the residue.

In the residue removing step 175, as shown in FIG. 5E, the residue removing liquid valve 50 is opened, and the first organic solvent (PGMEA, a dissolving liquid) as the residue removing liquid 94 is ejected from the first moving nozzle 9 toward the upper surface of the substrate W. The ejected residue removing liquid 94 receives a centrifugal force on the substrate W and spreads over the entire region of the principal surface Wf. The residue removing liquid 94 dissolves the residue of the processing film 100 remaining on the principal surface Wf of the substrate W and carries the residue out of the substrate W. For example, a paddle step may be performed in which the residue removing liquid 94 is ejected from the first moving nozzle 9 to the center of the upper surface of the substrate W while the substrate W is held and rotated (the rotational speed is, for example, about 300 rpm) by the spin chuck 5, and after the residue removing liquid 94 spreads over the entire region of the principal surface Wf of the substrate W, the rotation of the substrate W is decelerated or stopped to hold a liquid film of the residue removing liquid 94 on the substrate W. It is preferable to perform the paddle step for a time sufficient for the residue removing liquid 94 to dissolve the residue of the processing film 100. Thereafter, the elimination step of eliminating the residue removing liquid 94 in which the dissolved residue is dissolved to the outside of the substrate W is performed by rotating the substrate W by the spin chuck 5.

In the residue removing step 175, for example, the guard 71 may be disposed at a position where the second guard 71B receives the liquid shaken off outward from the substrate W. Accordingly, in the residue removing step 175, the residue removing liquid 94 discharged from the substrate W is received by the second guard 71B and guided to the second drain piping 60B. As described above, the residue removing step 175 is one example of a “second liquid supplying step” of supplying the residue removing liquid (first organic solvent, for example, PGMEA), which is one example of the “second liquid,” to the drain piping. The residue removing liquid piping 40, the residue removing liquid valve 50, the first moving nozzle 9 (residue removing liquid nozzle), the guard 71, etc., are examples of the “second liquid supplying portion.” The first moving nozzle 9 (residue removing liquid nozzle) is also one example of the “second liquid nozzle.”

The substrate processing method also includes, after the residue removing step 175, a rinsing step 176 of removing the residue removing liquid 94 (first organic solvent) on the substrate W (see FIG. 5F). Specifically, the second organic solvent (for example, IPA) is supplied as a rinse liquid 95 to the principal surface Wf of the substrate W to which the residue removing liquid 94 adheres, and the residue removing liquid 94 (first organic solvent) is replaced with the rinse liquid 95 (second organic solvent) and eliminated from the substrate W.

In the rinsing step 176, the rinse liquid valve 53 is opened, and the rinse liquid 95 (second organic solvent) is ejected from the second moving nozzle 10 toward the principal surface Wf (upper surface) of the substrate W. The ejected rinse liquid 95 receives a centrifugal force on the substrate W and spreads over the entire region of the principal surface Wf. The rinse liquid 95 replaces the residue removing liquid 94 (first organic solvent) remaining surface Wf of the substrate W and on the principal eliminates the residue removing liquid to the outside of the substrate W. For example, a paddle step may be performed in which the rinse liquid 95 is ejected from the second moving nozzle 10 to the center of the upper surface of the substrate W while the substrate W is held and rotated (the rotational speed is, for example, 800 rpm) by the spin chuck 5, and after the rinse liquid 95 spreads over the entire region of the substrate W (more accurately, the entire region of the upper surface of the processing film 100), the rotation of the substrate W is decelerated or stopped to hold a liquid film of the rinse liquid 95 on the substrate W. It is preferable to perform the paddle step for a time sufficient for the rinse liquid 95 to replace the residue removing liquid 94 on the substrate W. Thereafter, by rotating the substrate W by the spin chuck 5, the residue removing liquid 94 can be eliminated to the outside of the substrate W together with the rinse liquid 95.

In the rinsing step 176, for example, the guard 71 may be disposed at a position where the first guard 71A receives the liquid shaken off outward from the substrate W. Accordingly, in the rinsing step 176, the rinse liquid 95 discharged from the substrate W is received by the first guard 71A and guided to the first drain piping 60A.

The substrate processing method also includes, after the rinsing step 176, a drying step 177 (typically a spin drying step) for shaking off and drying the liquid on the surface of the substrate W (see FIG. 5G). The rinse liquid 95 (second organic solvent) on the surface of the substrate W is eliminated to the outside of the substrate W by a centrifugal force, and disappears from the surface of the substrate W by volatilization into the atmosphere. As in the rinsing step 176, the guard 71 may be disposed at a position where the first guard 71A receives the liquid shaken off outward from the substrate W.

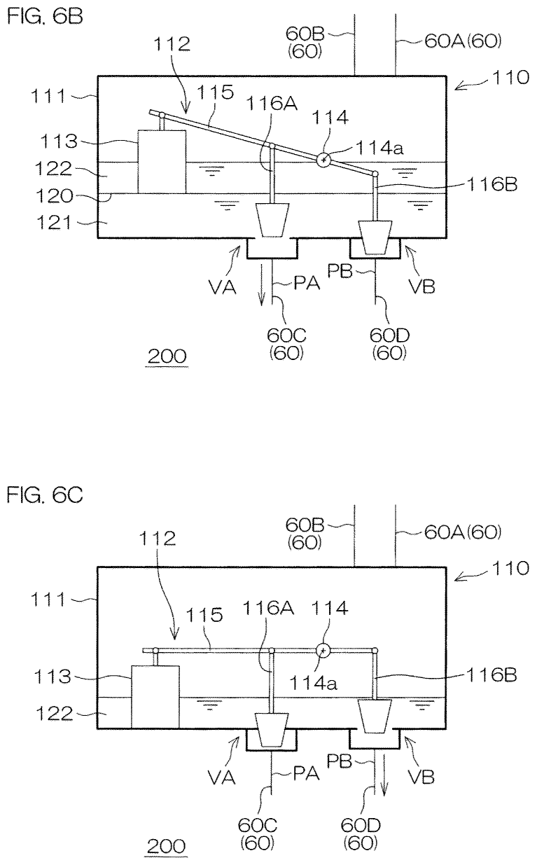

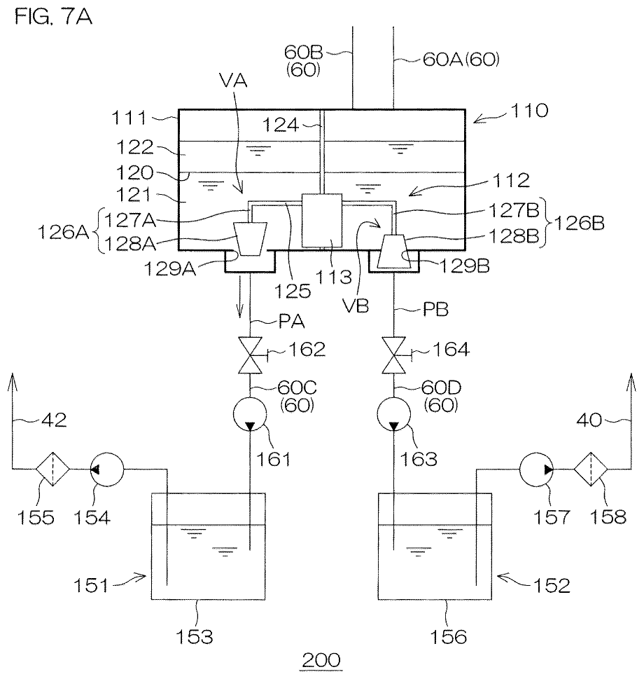

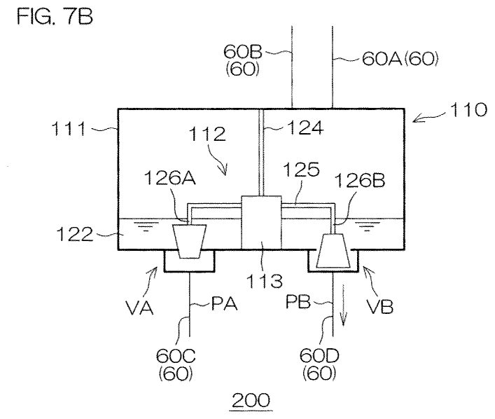

FIGS. 6A, 6B, and 6C illustrate a first configuration example of a drainage system 200. Further, FIGS. 7A and 7B illustrate a second configuration example of the drainage system 200.

The drainage system 200 includes a drain piping 60, a separator 110 provided in the drain piping 60, a first liquid storage 151, and a second liquid storage 152. The drain piping 60 includes a first drain piping 60A that guides a waste liquid received by the first guard 71A and a second drain piping 60B that guides the waste liquid received by the second guard 71B.

The separator 110 is connected to the first drain piping 60A and the second drain piping 60B, and includes a waste liquid trap tank 111 that commonly houses and stores the waste liquid from the first drain piping 60A and the second drain piping 60B.

In the elimination step 174 (see FIG. 5D), the film pieces of the processing film 100 are received by the first guard 71A together with the peeling liquid (DIW), and flow into the waste liquid trap tank 111 through the first drain piping 60A. In the residue removing step 175 (see FIG. 5E), the residue removing liquid (first organic solvent, PGMEA) obtained by dissolving the residue of the processing film 100 is received by the second guard 71B, and flows into the waste liquid trap tank 111 through the second drain piping 60B. Therefore, the peeling liquid (DIW) and the residue removing liquid (first organic solvent, PGMEA) are mixed in the waste liquid trap tank 111. In the rinsing step 176 (see FIG. 5F), the rinse liquid (second organic solvent, IPA) is received by the first guard 71A, and flows into the waste liquid trap tank 111 through the first drain piping 60A. Therefore, the peeling liquid (for example, DIW), the residue removing liquid (first organic solvent, PGMEA), and the rinse liquid (second organic solvent, IPA) are mixed in the waste liquid trap tank 111.

The film pieces of the processing film 100 flowing into the waste liquid trap tank 111 together with the peeling liquid are dissolved by the residue removing liquid (first organic solvent, PGMEA) also flowing into the waste liquid trap tank 111 (film piece dissolving step). Therefore, since the film pieces of the processing film 100 are resolved in the waste liquid trap tank 111, the risk of clogging the drain piping 60 can be reduced.

In this example, the first organic solvent (PGMEA), which is a residue removing liquid, is water-insoluble, so that the residue removing liquid and the peeling liquid (DIW) are incompatible with each other. The second organic solvent (IPA), which is a rinse liquid, is water-soluble, and the rinse liquid and the peeling liquid (DIW) are compatible with each other. Further, the processing film 100 is soluble in the residue removing liquid (first organic solvent, PGMEA), and insoluble or poorly soluble in the peeling liquid (DIW). Additionally, the processing film 100 is also insoluble or poorly soluble in the rinse liquid (second organic solvent, IPA).

Therefore, in the waste liquid trap tank 111, as shown in FIG. 6B, a first liquid layer 121 in which the peeling liquid and the rinse liquid (second organic solvent) are dissolved with each other and a second liquid layer 122 of the residue removing liquid (first organic solvent) in which the processing film is dissolved are formed, and an interface 120 that separates them vertically is formed. For example, when the density of the peeling liquid is higher than the density of the residue removing liquid (first organic solvent), the first liquid layer 121 is located on the lower side, and the second liquid layer 122 is located on the upper side.

The separator 110 further includes a first discharge port PA for mainly discharging the peeling liquid (example of the first liquid) from the waste liquid trap tank 111 and a second discharge port PB for mainly discharging the residue removing liquid (first organic solvent; example of the second liquid) from the waste liquid trap tank 111, which are connected to a bottom surface of the waste liquid trap tank 111. The separator 110 includes a valve mechanism 112 that opens one of the first discharge port PA and the second discharge port PB and closes the other of the first discharge port PA and the second discharge port PB. The valve mechanism 112 has a floating body 113 that moves up and down following the interface 120 between the first liquid layer 121 and the second liquid layer 122 in the waste liquid trap tank 111, and is configured to operate by the vertical movement of the floating body 113.

The drain piping 60 further includes a third drain piping 60C connecting the first discharge port PA of the waste liquid trap tank 111 and the first liquid storage 151, and a fourth drain piping 60D connecting the second discharge port PB of the waste liquid trap tank 111 and the second liquid storage 152. A pump 161 and a valve 162 are interposed in the third drain piping 60C. By opening the valve 162 and driving the pump 161, the liquid discharged from the first discharge port PA can be sent to the first liquid storage 151 through the third drain piping 60C. Similarly, a pump 163 and a valve 164 are interposed in the fourth drain piping 60D. By opening the valve 164 and driving the pump 163, the liquid discharged from the second discharge port PB can be sent to the second liquid storage 152 through the fourth drain piping 60D. The pumps 161 and 163 and the valves 162 and 164 are controlled by the controller 3 (see FIG. 3).

The first liquid storage 151 includes a first tank 153. The first tank 153 mainly collects a liquid containing the used peeling liquid (DIW). The liquid collected in the first tank 153 may be reused as the peeling liquid. That is, the peeling liquid piping 42 may be connected to the first tank 153, and a pump 154 and a filter 155 may be interposed in the peeling liquid piping 42. When the pump 154 is driven, the peeling liquid stored in the first tank 153 is pumped out, foreign matters (particles) are removed by the filter 155, and then the peeling liquid is supplied to the second moving nozzle 10 through the peeling liquid valve 52. In this case, the rinse liquid (second organic solvent; for example, IPA) is mixed in the peeling liquid to be reused, but since the rinse liquid (second organic solvent) hardly dissolves the processing film 100, only little influence acts on the peeling off the processing film 100. The pump 154 is controlled by the controller 3 (see FIG. 3).

The second liquid storage 152 includes a second tank 156. The second tank 156 mainly collects the used residue removing liquid (first organic solvent; for example, PGMEA). The liquid collected in the second tank 156 is preferably reused as the residue removing liquid. That is, the residue removing liquid piping 40 may be connected to the second tank 156, and a pump 157 and a filter 158 may be interposed in the residue removing liquid piping 40. When the pump 157 is driven, the residue removing liquid (first organic solvent) stored in the second tank 156 is pumped out, foreign matters (particles) are removed by the filter 158, and then the residue removing liquid is supplied to the first moving nozzle 9 through the residue removing liquid valve 50. In this case, the solute of the processing liquid (dissolved processing film 100) is dissolved in the residue removing liquid (first organic solvent) to be reused; however, only little influence acts on the dissolving and removing the residue of the processing film 100 on the substrate W. The pump 157 is controlled by the controller 3 (see FIG. 3).

As described above, the first liquid (mainly the peeling liquid) collected in the first liquid storage 151 can be reused in the peeling step. Similarly, the second liquid (mainly the residue removing liquid) collected in the second liquid storage 152 can be reused in the residue removing step as described above. Therefore, since the use amount of the peeling liquid and the residue removing liquid (first organic solvent) can be reduced, the liquid consumption can be reduced, and this can contribute to the reduction of the environmental load and the running cost.

In a first configuration example illustrated in FIGS. 6A, 6B, and 6C, the valve mechanism 112 includes a lever 115 pivotably supported by a fulcrum 114 fixed with respect to the waste liquid trap tank 111, a first valve member 116A and a second valve member 116B coupled to the lever 115, and a floating body 113 coupled to the lever 115. The lever 115 is supported to be pivotable around a horizontal pivoting axis 114a at the fulcrum 114. The first valve member 116A and the second valve member 116B are coupled to the lever 115 at positions opposite to each other with respect to the fulcrum 114. The floating body 113 is coupled to the lever 115 on the side opposite to the fulcrum 114 with respect to the first valve member 116A.

The first valve member 116A includes a first valve rod 117A having a proximal end portion (an upper end portion in the illustrated example) coupled to the lever 115, and a first valve element 118A fixed to a distal end portion (a lower end portion in the illustrated example) of the first valve rod 117A. The first valve element 118A can be seated on a first valve seat 119A provided in the first discharge port PA. The first valve member 116A and the first valve seat 119A constitute a first valve VA. The first valve VA is opened and closed by the vertical movement of the first valve member 116A, and communicates the storage space of the waste liquid trap tank 111 with the first discharge port PA (third drain piping 60C.).

Similarly, the second valve member 116B includes a second valve rod 117B having a proximal end portion (an upper end portion in the illustrated example) coupled to the lever 115, and a second valve element 118B fixed to a distal end portion (a lower end portion in the illustrated example) of the second valve rod 117B. The second valve element 118B can be seated on a second valve seat 119B provided in the second discharge port PB. The second valve member 116B and the second valve seat 119B constitute a second valve VB. The second valve VB is opened and closed by the vertical movement of the second valve member 116B, and communicates the storage space of the waste liquid trap tank 111 with the second discharge port PB (fourth drain piping 60D).

The floating body 113 is configured such that its average density has a value between the density of the residue removing liquid (first organic solvent) and the density of the peeling liquid. The average density refers to a value obtained by dividing the mass of the floating body 113 by the volume of the floating body 113. Here, the floating body 113 is configured such that its average density is larger than the density of the residue removing liquid (first organic solvent) and smaller than the density of the peeling liquid. Consequently, the floating body 113 floats up to the liquid level in the peeling liquid, and sinks in the residue removing liquid (first organic solvent) into the liquid. Therefore, when the first liquid layer 121 and the second liquid layer 122 are present in the waste liquid trap tank 111, the floating body 113 is located near the interface 120. When the interface 120 moves up and down due to inflow of the peeling liquid, the residue removing liquid (first organic solvent), the rinse liquid (second organic solvent), the film pieces of the processing film, etc., the floating body 113 moves up and down so as to follow the interface 120.

As illustrated in FIG. 6A, when no liquid is stored in the waste liquid trap tank 111, the floating body 113 is positioned in contact with the bottom surface of the waste liquid trap tank 111. In this state, the valve mechanism 112 is designed such that the first valve VA closes the first discharge port PA and the second valve VB opens the second discharge port PB.

As illustrated in FIG. 6B, when the first liquid layer 121 and the second liquid layer 122 are present in the waste liquid trap tank 111, the floating body 113 is located higher the bottom surface of the waste liquid trap tank 111, so that the lever 115 lifts up the first valve member 116A and pushes down the second valve member 116B. Accordingly, the first valve VA opens the first discharge port PA, and the second valve VB closes the second discharge port PB. Therefore, the liquid (mainly the peeling liquid) constituting the first liquid layer 121 located on the lower side flows out from the first discharge port PA to the third drain piping 60C and is discharged to the first liquid storage 151 (first discharging step).

When the interface 120 between the first liquid layer 121 and the second liquid layer 122 is lowered by this drainage and the floating body 113 is displaced downward accordingly, the lever 115 pushes down the first valve member 116A and lifts up the second valve member 116B. When the first liquid layer 121 disappears, the floating body 113 comes into contact with the bottom surface of the waste liquid trap tank 111 as illustrated in FIG. 6C. Accordingly, the first valve VA closes the first discharge port PA, and the second valve VB opens the second discharge port PB. Therefore, the liquid (mainly the residue removing liquid (first organic solvent)) constituting the second liquid layer 122 flows out from the second discharge port PB to the fourth drain piping 60D and is discharged to the second liquid storage 152 (second discharging step).

In this manner, the liquid (e.g. peeling liquid) constituting the first liquid layer 121 and the liquid (e.g. residue removing liquid) constituting the second liquid layer 122 can be separated by the separator 110 (separation step 178; see FIG. 4) and collected in the first liquid storage 151 and the second liquid storage 152, respectively (collecting step 179; see FIG. 4).

In a second configuration example illustrated in FIGS. 7A and 7B, the valve mechanism 112 includes a floating body 113 that moves up and down by being guided by a guide rail 124 in the waste liquid trap tank 111, a lifting member 125 that is coupled to the floating body 113 and moves up and down together with the floating body 113, and a first valve member 126A and a second valve member 126B that are coupled to the lifting member 125.

The first valve member 126A includes a first valve rod 127A having a proximal end portion (an upper end portion in the illustrated example) coupled to the lifting member 125, and a first valve element 128A fixed to a distal end portion (a lower end portion in the illustrated example) of the first valve rod 127A. The first valve element 128A can be seated on a first valve seat 129A provided in the first discharge port PA from above. The first valve member 126A and the first valve seat 129A constitute a first valve VA. The first valve VA is opened by an upward movement of the first valve member 126A and closed by a downward movement thereof to open and close between the storage space of the waste liquid trap tank 111 and the first discharge port PA (third drain piping 60C.).

The second valve member 126B includes a second valve rod 127B having a proximal end portion (an upper end portion in the illustrated example) coupled to the lifting member 125, and a second valve element 1 fixed to a distal end portion (a lower end portion in the illustrated example) of the second valve rod 127B. The second valve element 128B can be seated on a second valve seat 129B provided in the second discharge port PB from below. The second valve member 126B and the second valve seat 129B constitute a second valve VB. The second valve VB is opened by an upward movement of the second valve member 126B and closed by a downward movement thereof to open and close between the storage space of the waste liquid trap tank 111 and the second discharge port PB (fourth drain piping 60D).

A relationship among the average density of the floating body 113, the density of the residue removing liquid (first organic solvent), and the density of the peeling liquid is the same as in the first configuration example. Consequently, the floating body 113 floats up to the liquid level in the peeling liquid, and sinks in the residue removing liquid (first organic solvent) into the liquid. Therefore, when the first liquid layer 121 and the second liquid layer 122 are formed in the waste liquid trap tank 111, the floating body 113 moves toward the vicinity of the interface 120. When the interface 120 moves up and down due to inflow of the peeling liquid, the residue removing liquid (first organic solvent), the rinse liquid (second organic solvent), the film pieces of the processing film, etc., the floating body 113 moves up and down so as to follow the interface 120. However, the downward movement of the floating body 113 is restricted by seating of the first valve member 126A on the first valve seat 129A from above, and the upward movement of the floating body 113 is restricted by seating of the second valve member 126B on the second valve seat 129B from below.

As illustrated in FIG. 7A, when the first liquid layer 121 and the second liquid layer 122 are present in the waste liquid trap tank 111, the floating body 113 is located above a lower limit position, so that the lifting member 125 lifts up the first valve member 126A and the second valve member 126B. Accordingly, the first valve VA opens the first discharge port PA, and the second valve VB closes the second discharge port PB. Therefore, the liquid (mainly the peeling liquid) constituting the first liquid layer 121 located on the lower side flows out from the first discharge port PA to the third drain piping 60C and is discharged to the first liquid storage 151 (first discharging step).

When the interface 120 between the first liquid layer 121 and the second liquid layer 122 is lowered by this drainage and the lifting member 125 descends together with the floating body 113 accordingly, the first valve member 126A and the second valve member 126B descend accordingly. When the first liquid layer 121 disappears, the floating body 113 is disposed at the lower limit position as illustrated in FIG. 7B. Accordingly, the first valve VA closes the first discharge port PA, and the second valve VB opens the second discharge port PB. Therefore, the liquid (mainly the residue removing liquid (first organic solvent)) constituting the second liquid layer 122 flows out from the second discharge port PB to the fourth drain piping 60D and is discharged to the second liquid storage 152 (second discharging step).

In this manner, the first liquid (e.g. peeling liquid) constituting the first liquid layer 121 and the second liquid (e.g. residue removing liquid) constituting the second liquid layer 122 can be separated by the separator 110 (separation step 178; see FIG. 4) and collected in the first liquid storage 151 and the second liquid storage 152, respectively (collecting step 179; see FIG. 4).

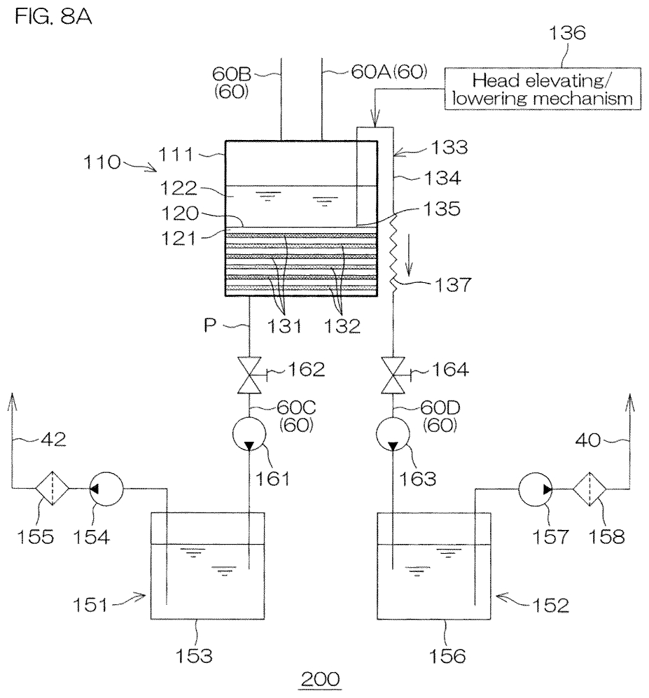

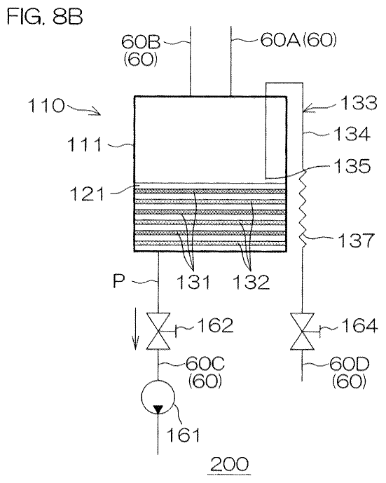

FIGS. 8A and 8B illustrate a third configuration example of the drainage system 200. In FIGS. 8A and 8B, corresponding parts of the configurations to those illustrated in FIGS. 6A to 6C and FIGS. 7A to 7B described above are denoted by the same reference numerals, and description thereof is omitted.

The drainage system 200 includes a drain piping 60, a separator 110 provided in the drain piping 60, a first liquid storage 151, and a second liquid storage 152. The drain piping 60 includes a first drain piping 60A that guides a waste liquid received by the first guard 71A (see FIG. 2) and a second drain piping 60B that guides the waste liquid received by the second guard 71B (see FIG. 2).

Also in this configuration example, the separator 110 is connected to the first drain piping 60A and the second drain piping 60B, and includes a waste liquid trap tank 111 that houses and stores the waste liquid from the first drain piping 60A and the second drain piping 60B in common. In the waste liquid trap tank 111, the progress of dissolution of the film pieces is similar to that in the first and second configuration examples (film piece dissolving step).

On the other hand, in this configuration example, the separator 110 does not include the valve mechanism 112 (see FIGS. 6A and 7A), but instead includes a chiller 131 (cooling unit) equipped in the waste liquid trap tank 111. In this configuration example, the separator 110 further includes a heating unit 132 equipped in the waste liquid trap tank 111. The chiller 131 cools the liquid housed in the waste liquid trap tank 111. More specifically, the chiller 131 is operated so as to freeze one of the first liquid layer 121 and the second liquid layer 122 separated vertically in the waste liquid trap tank 111, whichever has a higher melting point, to transition to the solid phase, and to maintain the other having a lower melting point in the liquid phase. The heating unit 132 heats the liquid layer (one of the first liquid layer 121 and the second liquid layer 122) that has transitioned to the solid phase by the chiller 131 to return to the liquid phase.

For example, when the density of the peeling liquid is higher than the density of the residue removing liquid (first organic solvent), the first liquid layer 121 is located on the lower side, and the second liquid layer 122 is located on the upper side. This magnitude relationship of the density is also appropriate, for example, when the peeling liquid is DIW and the first organic solvent used as the residue removing liquid is PGMEA. On the other hand, the melting point of DIW is 0° C., and the melting point of PGMEA is −67° C. Therefore, the chiller 131 cools the liquid in the waste liquid trap tank 111 to a temperature higher than −67° C. and equal to or lower than 0° C., freezes the peeling liquid (DIW) forming the first liquid layer 121, and maintains the residue removing liquid (PGMEA) forming the second liquid layer 122 in the liquid phase. Since the first liquid layer 121 is located on the lower side, the chiller 131 is disposed in a relatively lower region of the waste liquid trap tank 111, and the first liquid layer 121 can be efficiently cooled. The same applies to the arrangement of the heating unit 132, and the first liquid layer 121 that has transitioned to the solid phase can be efficiently heated.

The chiller 131 is preferably equipped in the waste liquid trap tank 111 in an arrangement that is likely to come into contact with one of the first liquid layer 121 and the second liquid layer 122, whichever has a higher melting point (that is, the liquid layer to be transitioned to the solid phase), ensuring that efficient cooling can be performed. Similarly, the heating unit 132 is also preferably equipped in the waste liquid trap tank 111 in an arrangement that is likely to come into contact with one of the first liquid layer 121 and the second liquid layer 122, whichever has a higher melting point (that is, the liquid layer to be transitioned to the solid phase), ensuring that efficient heating can be performed. However, as described later, after drainage of the liquid layer maintained in the liquid phase to the outside of the waste liquid trap tank 111, the heating unit 132 heats the liquid layer that has transitioned to the solid phase. In a case where the liquid layer that has transitioned to the solid phase moves to the lower side of the waste liquid trap tank 111 by gravity due to the drainage of the liquid layer maintained in the liquid phase, the heating unit 132 is preferably equipped in a relatively lower region of the waste liquid trap tank 111, thereby increasing the heating efficiency. Since transition from the solid phase to the liquid phase may be achieved by natural thawing, equipping the heating unit 132 is not essential.

The chiller 131 and the heating unit 132 are controlled by the controller 3 (see FIG. 3). The chiller 131 may be a rod-shaped cooler, and for example, Chiller series manufactured by SANOX Corp., or Coolant Chiller manufactured by TAKAKIKAISAN Co., Ltd., can be used. The heating unit 132 may be a rod-shaped heater.

The separator 110 further includes a discharge port P for mainly discharging the peeling liquid (first liquid: liquid having a relatively high melting point) from the waste liquid trap tank 111, and the discharge port P is connected to the bottom surface of the waste liquid trap tank 111. The separator 110 further includes a suction unit 133 for mainly sucking out the residue removing liquid (first organic solvent (second liquid): a liquid having a relatively low melting point and maintained in the liquid phase) from the waste liquid trap tank 111. The suction unit 133 includes a suction piping 134. The suction piping 134 has a suction head 135 to be introduced into the waste liquid trap tank 111 at the tip, and is provided with a head elevating/lowering mechanism 136 for moving the suction head 135 up and down. The suction piping 134 may include an expansion pipe portion 137 that absorbs vertical movement by the head elevating/lowering mechanism 136 in the middle. The head elevating/lowering mechanism 136 is controlled by the controller 3 (see FIG. 3).

The drain piping 60 includes a third drain piping 60C connecting the discharge port P of the waste liquid trap tank 111 and the first liquid storage 151, and a fourth drain piping 60D connecting the suction unit 133 and the second liquid storage 152.

As described above, in the waste liquid trap tank 111, a first liquid layer 121 in which the peeling liquid and the rinse liquid (second organic solvent) are dissolved with each other and a second liquid layer 122 of the residue removing liquid (first organic solvent) in which the processing film is dissolved are formed, and an interface 120 that separates them vertically is formed. For example, when the density of the peeling liquid is higher than the density of the residue removing liquid (first organic solvent), the first liquid layer 121 is located on the lower side, and the second liquid layer 122 is located on the upper side.

In this manner, the controller 3 operates the chiller 131 in a state of being separated into the first liquid layer 121 and the second liquid layer 122. Accordingly, the first liquid layer 121 mainly containing the peeling liquid (DIW) is frozen and transitions from the liquid phase to the solid phase (freezing step).

After the first liquid layer 121 is frozen, the head elevating/lowering mechanism 136 is operated by the controller 3, and the suction head 135 is lowered from above the interface 120 in the waste liquid trap tank 111. The suction head 135 is lowered until it butts against the surface of the frozen first liquid layer 121, thereby being positioned at the interface 120. In this state, the suction unit 133 is operated. Specifically, the valve 164 disposed in the fourth drain piping 60D is opened by the controller 3, and the pump 163 is operated. Therefore, the liquid (mainly residue removing liquid) constituting the second liquid layer 122 maintained in the liquid phase is sucked from the suction head 135 to the suction piping 134, guided to the fourth drain piping 60D, and guided to the second liquid storage 152 through the fourth drain piping 60D. In this way, the liquid constituting the second liquid layer 122 is sucked by the suction unit 133 and discharged from the waste liquid trap tank 111 to the second liquid storage 152 (first discharging step). When the second liquid layer 122 disappears, the controller 3 closes the valve 164, stops the pump 163, and stops the suction operation of the suction unit 133. Note that the suction unit 133 may include a pump different from the pump 163 as a suction source. The suction unit 133, etc., constitutes one example of the “discharge unit.” The suction piping 134 is one example of the “liquid phase discharge piping.”

Next, the controller 3 stops the cooling by the chiller 131 and heats the first liquid layer 121 of the solid phase by the heating unit 132. Accordingly, the first liquid layer 121 is melted and transitions from the solid phase to the liquid phase (melting step). Thereafter, the controller 3 opens the valve 162 of the third drain piping 60C and operates the pump 161. Therefore, the liquid (mainly the peeling liquid) constituting the first liquid layer 121 is discharged out from the discharge port P of the waste liquid trap tank 111 to the first liquid storage 151 through the third drain piping 60C (second discharging step).

Since the liquid constituting the first liquid layer 121 can be discharged using gravity, the pump 161 may be omitted.

In this manner, the first liquid (e.g. peeling liquid) constituting the first liquid layer 121 and the second liquid (e.g. residue removing liquid) constituting the second liquid layer 122 can be separated by the separator 110 (separation step 178; see FIG. 4) and collected in the first liquid storage 151 and the second liquid storage 152, respectively (collecting step 179; see FIG. 4).

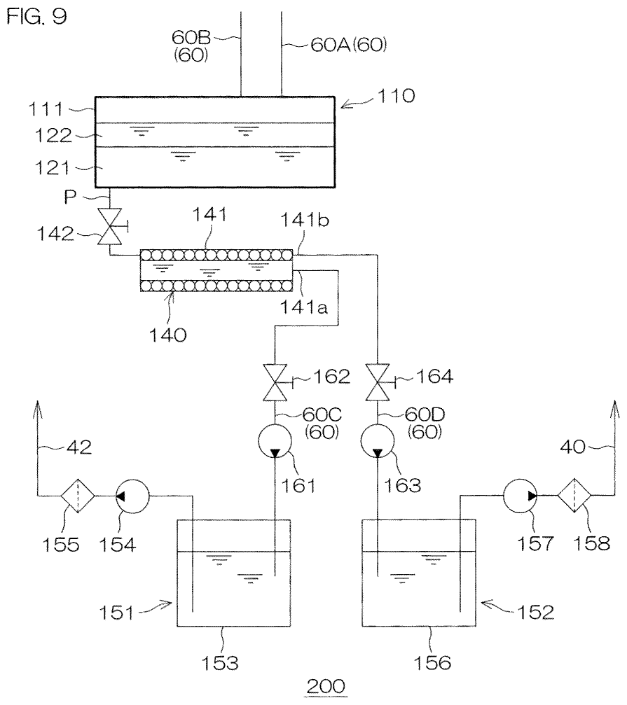

FIG. 9 illustrates a fourth configuration example of the drainage system. In FIG. 9, corresponding parts of the configurations to those illustrated in FIGS. 6A to 6C, FIGS. 7A and 7B, and FIGS. 8A and 8B described above are denoted by the same reference numerals, and description thereof is omitted.

The drainage system 200 includes a drain piping 60, a separator 110 provided in the drain piping 60, a first liquid storage 151, and a second liquid storage 152. The drain piping 60 includes a first drain piping 60A that guides a waste liquid received by the first guard 71A and a second drain piping 60B that t guides the waste liquid received by the second guard 71B.

Also in this configuration example, the separator 110 is connected to the first drain piping 60A and the second drain piping 60B, and includes a waste liquid trap tank 111 that houses and stores the waste liquid from the first drain piping 60A and the second drain piping 60B in common. In the waste liquid trap tank 111, the progress of dissolution of the film pieces is similar to that in the first to third configuration examples (film piece dissolving step).

On the other hand, in this configuration example, the separator 110 does not include the valve mechanism 112 (see FIGS. 6A and 7A), the suction unit 133 (see FIG. 8A), etc., but includes an ion exchange resin unit 140 connected to the discharge port P through the fifth drain piping 60E. A valve 142 controlled by the controller 3 (see FIG. 3) is interposed in the fifth drain piping 60E. The ion exchange resin unit 140 includes one or more ion exchange resin columns 141. The ion exchange resin column 141 contains, for example, a cation exchange resin that adsorbs acetate ions, thereby selectively extracting one of the first liquid (for example, water) and the second liquid (for example, organic solvent) to separate them. Then, the ion exchange resin column 141 discharges the first liquid from a first port 141a and discharges the second liquid from a second port 141b. Therefore, the third drain piping 60C is connected to the first port 141a, and the fourth drain piping 60D is connected to the second port 141b. If necessary, by connecting the plurality of ion exchange resin columns 141 in parallel between the fifth drain piping 60E and the drain piping 60C and 60D, it is possible to enhance the liquid separation processing capability.

When the valve 142 is opened and the liquid in the waste liquid trap tank 111 is supplied from the discharge port P to the ion exchange resin unit 140, the peeling liquid (DIW) and the rinse liquid (second organic solvent, IPA) are discharged from the first port 141a of the ion exchange resin column 141, and the residue removing liquid (first organic solvent) is discharged from the second port 141b of the ion exchange resin column 141. Thereby, the peeling liquid (DIW) can be guided to the first liquid storage 151, and the residue removing liquid (first organic solvent, PGMEA) can be guided to the second liquid storage 152.

In this manner, the first liquid (peeling liquid) and the second liquid (residue removing liquid) can be separated by the separator 110 (ion exchange resin unit 140) (separation step 178; see FIG. 4) and collected in the first liquid storage 151 and the second liquid storage 152, respectively (collecting step 179; see FIG. 4).

Specific examples of the ion exchange resin column 141 constituting the ion exchange resin unit 140 may include AG 50W-X8 and AG 50W-x12 provided by Bio-Rad Corp., Ionac AG-1 provided by Merck Millipore Corp., XBridge series provided by Waters Corp., and Eclipse series provided by Agilent Technologies Corp.

Since the two liquids separated by the ion exchange resin unit 140 do not need to be separated into two liquid layers in the waste liquid trap tank 111, they may be compatible with each other, may have similar densities, and may have similar melting points.

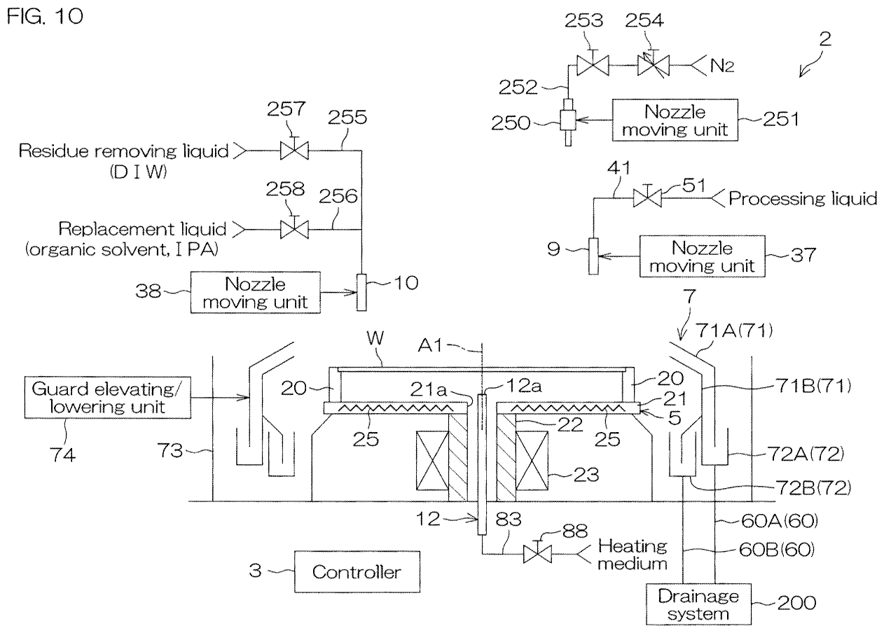

FIG. 10 illustrates a configuration example of the processing unit according to another preferred embodiment of the present invention. Description of this preferred embodiment will be made while referring again to FIG. 1 described above. That is, FIG. 10 illustrates another configuration example of the processing unit 2 included in the substrate processing apparatus 1. In FIG. 10, corresponding parts to those in FIG. 2 are denoted by the same reference numerals, and description thereof is omitted.

In this preferred embodiment, the processing film is peeled off without using the peeling liquid. That is, the peeling liquid supplying unit is not provided. Instead, a peeling gas nozzle 250 that ejects a peeling gas toward the upper surface of the substrate W is provided. The peeling gas nozzle 250 is one example of the fluid nozzle, one example of the gas peeling unit, and one example of the “peeling portion.”

The peeling gas nozzle 250 is moved in a horizontal direction and in a vertical direction by a third nozzle moving unit 251. The third nozzle moving unit 251 moves the peeling gas nozzle 250 along an arc-shaped path that runs substantially along the diameter of the substrate W, along the upper surface of the substrate W. The third nozzle moving unit 251 has the same arrangement as the first nozzle moving unit 37. That is, the third nozzle moving unit 251 includes, for example, a pivoting shaft (not shown) oriented along the vertical direction, an arm (not shown) that is coupled to the pivoting shaft and the peeling gas nozzle 250 and extends horizontally, and a pivoting shaft driving unit (not shown) that elevates, lowers, and pivots the pivoting shaft.

The peeling gas nozzle 250 is connected to a peeling gas piping 252 that guides the peeling gas to the peeling gas nozzle 250. When an opening/closing valve 253 attached to the peeling gas piping 252 is opened, the peeling gas is continuously ejected downward from an ejection port of the peeling gas nozzle 250 at a flow rate corresponding to the opening degree of a flow control valve 254 that changes the flow rate of the peeling gas. FIG. 10 shows an example in which the peeling gas nozzle 250 ejects nitrogen gas, which is one example of the peeling gas. The peeling gas may be an inert gas other than the nitrogen gas, or may be a gas other than the inert gas.

As in the preferred embodiment described above, the first moving nozzle 9 is connected to the processing liquid piping 41 that guides the processing liquid. When a processing liquid valve 51 interposed in the processing liquid piping 41 is opened, the processing liquid is ejected continuously downward from the first moving nozzle 9.

However, in this example, the processing liquid uses a water-soluble solvent, and thus the processing film formed by hardening of the processing liquid on the substrate W is soluble in DIW. Therefore, DIW is not used for peeling off the processing film, and the processing film is peeled off by blowing the peeling gas.

The processing liquid (polymer solution) is a solution containing a polymer corresponding to the solute and a solvent in which the polymer is soluble. The polymer is a water-soluble polymer (hydrophilic polymer) soluble in water. The solvent is, for example, water. Therefore, the processing liquid is a polymer aqueous solution. The processing liquid may contain components other than the water-soluble polymer and water. The solvent may be a liquid of an amphiphile having a hydrophilic group and a hydrophobic group in one molecule. A water-soluble organic solvent (for example, PGME) may be used as the solvent.

The water-soluble polymer is a polymer in which a hydrophilic group such as a carboxyl group, a hydroxyl group, or a sulfonic acid group is disposed at the end of a molecule. The water-soluble polymer may contain at least one of a water-soluble acrylic resin, a water-soluble polyester, and a water-soluble polyurethane, or may contain a polymer other than these. The water-soluble acrylic resin may be at least one of an OH group acrylic resin and a hydroxyl group acrylic resin. The water-soluble polymer may be a polymer that is insoluble or poorly soluble in oil, or may be a polymer that is also soluble in oil. In the latter case, the solubility of the water-soluble polymer in water is greater than the solubility of the water-soluble polymer in oil.

In this preferred embodiment, the second moving nozzle 10 is one example of the residue removing liquid nozzle (residue removing liquid supplying unit, residue removing processing portion) that supplies (ejects) the residue removing liquid (for example, DIW) toward the upper surface of the substrate W held by the spin chuck 5. In this preferred embodiment, the second moving nozzle 10 is also one example of a replacement liquid nozzle (replacement liquid supplying unit, replacement processing portion) that supplies (ejects) a replacement liquid (for example, IPA) toward the upper surface of the substrate W held by the spin chuck 5. Of course, the residue removing liquid supplying unit and the replacement liquid supplying unit may include individual nozzles.

The second moving nozzle 10 is connected to a residue removing liquid piping 255 that guides the residue removing liquid to the second moving nozzle 10. When a residue removing liquid valve 257 interposed in the residue removing liquid piping 255 is opened, the residue removing liquid is continuously ejected downward from the ejection port of the second moving nozzle 10.

The second moving nozzle 10 is also connected to a replacement liquid piping 256 that guides the replacement liquid to the second moving nozzle 10. When a replacement liquid valve 258 interposed in the replacement liquid piping 256 is opened, the rinse liquid (second organic solvent) is continuously ejected downward from the ejection port of the second moving nozzle 10.

The residue removing liquid is a liquid for dissolving and removing the residue of the processing film from the substrate W, and is a dissolving liquid capable of dissolving the processing film. When the processing film is water-soluble, an aqueous liquid such as DIW can be used. The replacement liquid is a liquid that replaces the residue removing liquid on the substrate W, and when the residue removing liquid is DIW, for example, IPA can be used.

The controller 3 controls the spin motor 23, the valves 88, 253, 257, and 258, the nozzle moving units 37 and 38, 251, the guard elevating/lowering unit 74, the heater 25, and other elements, and also controls the drainage system 200.

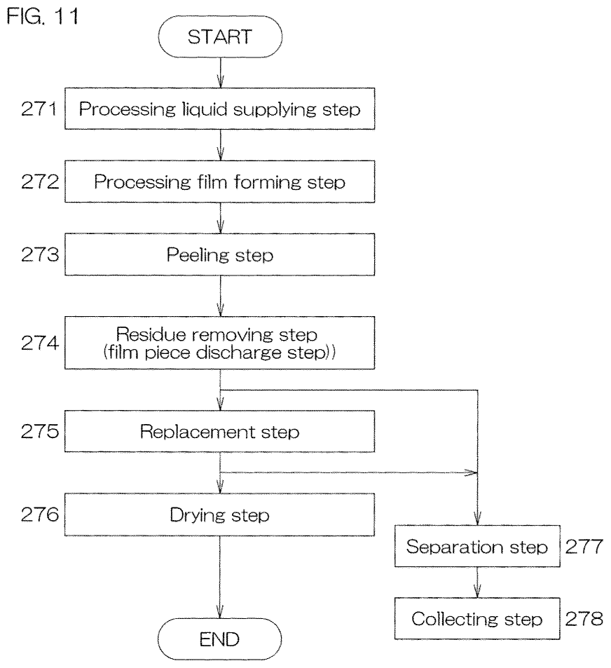

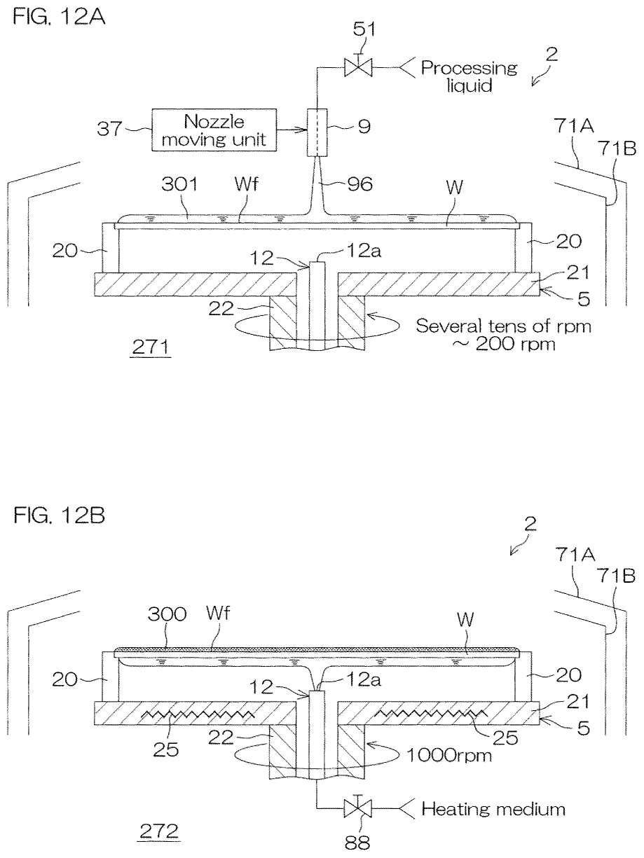

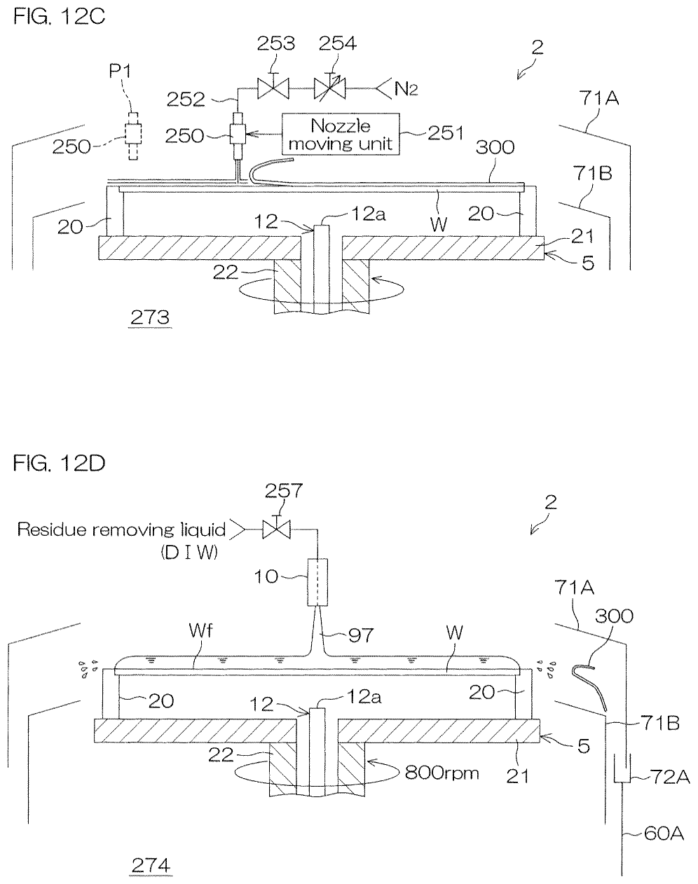

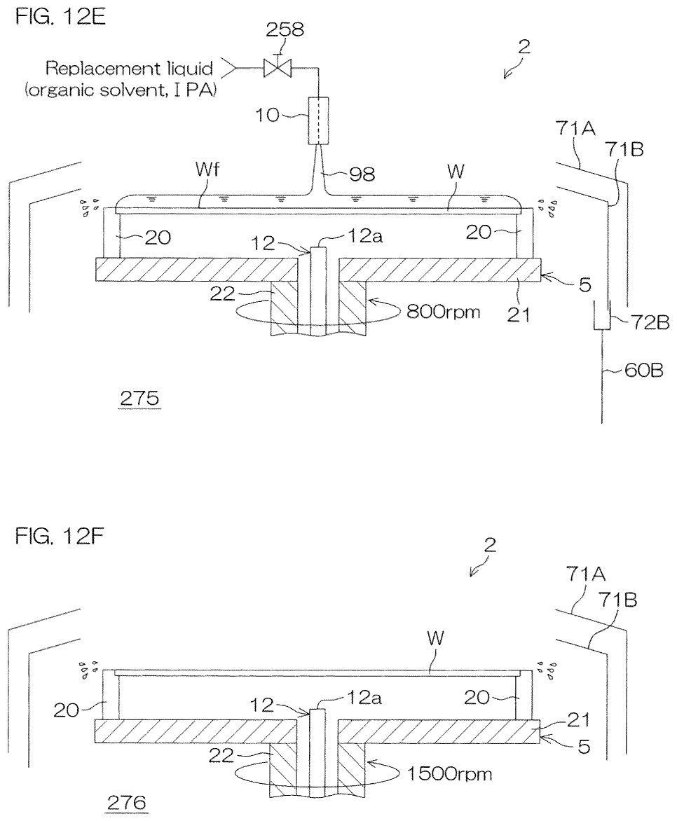

FIG. 11 is a flowchart for describing an example of a substrate processing method executed by the processing unit 2 in this preferred embodiment and FIGS. 12A to 12F are diagrams for describing a state of main steps. The substrate W to be processed is as described in the above preferred embodiment.

The substrate processing method includes a processing liquid supplying step 271 (see FIG. 12A) of supplying the processing liquid 96 to the principal surface Wf of the substrate W, and a processing film forming step 272 (see FIG. 12B) of solidifying or curing the processing liquid 96 on the principal surface Wf to form the processing film 300 on the principal surface Wf.

In the processing liquid supplying step 271, as shown in FIG. 12A, the processing liquid valve 51 is opened while the substrate W is held and rotated by the spin chuck (the rotational speed is, for example, several tens of rpm ˜200 rpm), and the processing liquid 96 is ejected from the first moving nozzle 9 toward the center of the upper surface of the substrate W. The ejected processing liquid 96 receives a centrifugal force on the substrate W, spreads over the entire region of the substrate W, and forms a processing liquid film 301 (liquid film of the processing liquid 96) covering the entire region of the substrate W. That is, the processing liquid film 301 covering the entire region of the principal surface Wf of the substrate W is formed by so-called spin coating. At this time, for example, the guard 71 may be disposed at a position where the second guard 71B receives the liquid shaken off outward from the substrate W.

In the processing film forming step 272, as shown in FIG. 12B, the solvent component of the processing liquid film 301 formed on the principal surface Wf is evaporated, whereby the processing liquid film 301 is solidified or cured to form the processing film 300. Specifically, the processing liquid valve 51 is closed, and the ejection of the processing liquid 96 from the first moving nozzle 9 is stopped. The rotation of the substrate W is continued by the spin motor 23 driving the spin chuck 5, and the rotation may be accelerated as necessary (for example, accelerated to about 1000 rpm). Consequently, the solvent in the processing liquid film 301 is evaporated. In order to promote evaporation of the solvent, heating of the substrate W may be used in combination. The heating of the substrate W can be performed by opening the heating medium valve 88 and ejecting the heating medium from the ejection port 12a of the lower surface nozzle 12 toward the lower surface of the substrate W (the principal surface opposite to the principal surface Wf). Further, the heating of the substrate W can also be performed by energizing the heater provided on the spin base 21. The processing film 300 in a semi-solidified or semi-cured state may be formed by the rotation of the substrate W by the spin chuck 5, and the processing film 300 may be heated through the substrate W to promote the evaporation of the solvent, thereby forming the completely solidified or cured processing film 300. The spin motor 23, the lower surface nozzle 12, the heating medium valve 88, the heater 25, etc., are examples of the “processing film forming portion.”

The substrate processing method includes, after the processing film forming step 272, a peeling step 273 of peeling off the processing film 300 from the principal surface Wf and removing it to the outside of the substrate W (see FIG. 12C). The peeling step 273 is a gas peeling step performed by ejection of peeling gas.

Specifically, for example, the substrate W held by the spin chuck 5 is rotated at a peeling speed by the spin motor 23 in a state where the first guard 71A faces the end surface of the substrate W (the rotational speed is, for example, about several tens of rpm). In this state, the third nozzle moving unit 251 moves the peeling gas nozzle 250 from a standby position to a processing position. Thereafter, the opening/closing valve 253 is opened, and the peeling gas nozzle 250 starts the ejection of the peeling gas. When a predetermined time elapses from when the opening/closing valve 253 was opened, the opening/closing valve 253 is closed and the ejection of the peeling gas is stopped. Thereafter, the third nozzle moving unit 251 moves the peeling gas nozzle 250 to the standby position.

When the peeling gas nozzle 250 ejects the peeling gas toward the upper surface of the substrate W covered with the processing film 300, the processing film 300 in close contact with the entire upper surface of the substrate W is peeled off from the substrate W and removed from the substrate W.

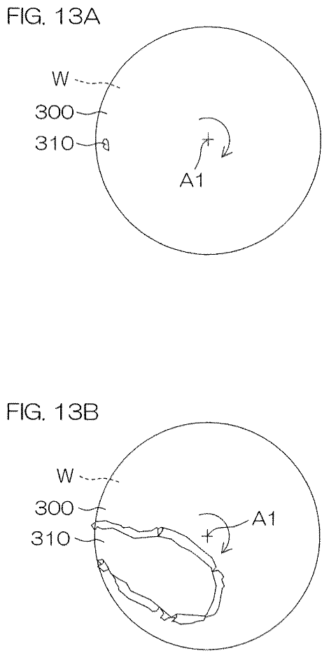

More specifically, for example, as shown in FIG. 13A, the peeling gas nozzle 250 starts the ejection of the peeling gas while standing still at a first ejection position P1 where the peeling gas is blown onto the upper surface of the substrate W between the center of the substrate W and the outer periphery of the substrate W. The substrate W is in a rotating state. As the substrate W rotates while blowing the peeling gas, the film thickness of the processing film 300 locally decreases on the circumference concentric with the substrate W, and finally, a through hole 310 is formed. The peeling gas enters between the processing film 300 and the substrate W through the through hole 310, and applies a peeling force for peeling off the processing film 300 from the substrate W to the processing film 300. The processing film 300 is further peeled off from the substrate W by this peeling force (see FIG. 13B). The third nozzle moving unit 251 may move the peeling gas nozzle 250 toward the rotation center as necessary. In this way, by the ejection of the peeling gas from the peeling gas nozzle 250, the entire processing film 300 can be peeled off from the surface of the substrate W without using the peeling liquid. The peeled processing film is received by the guard 71 (for example, the first guard 71A).

As shown in FIG. 11, in this example, after the peeling step 273, the substrate processing method includes a residue removing step 274 of supplying DIW as a residue removing liquid 97 to the principal surface Wf of the substrate W to dissolve the residue of the processing film 300 and removing the residue from the pattern surface (see FIG. 12D). In this case, DIW as the residue removing liquid 97 is also a dissolving liquid for dissolving the residue of the processing film 300.

In the residue removing step 274, the residue removing liquid valve 257 is opened, and the residue removing liquid 97 (DIW) is ejected from the second moving nozzle 10 toward the upper surface of the substrate W. The ejected residue removing liquid 97 receives a centrifugal force on the substrate W and spreads over the entire region of the substrate W. The residue removing liquid 97 dissolves the residue of the processing film 300 remaining on the principal surface Wf of the substrate W and carries the residue out of the substrate W. For example, a paddle step may be performed in which the residue removing liquid 97 is ejected from the second moving nozzle 10 to the center of the upper surface of the substrate W while the substrate W is held and rotated by the spin chuck 5, and after the residue removing liquid 97 spreads over the entire region of the principal surface Wf, the rotation of the substrate W is decelerated or stopped to hold a liquid film of the residue removing liquid 97 on the substrate W. It is preferable to perform the paddle step for a time sufficient for the residue removing liquid 97 to dissolve the residue of the processing film 300. Thereafter, the elimination step of eliminating the residue removing liquid 97 in which the dissolved processing film 300 is dissolved to the outside of the substrate W is performed by rotating the substrate W by the spin chuck 5.

In the residue removing step 274, for example, the guard 71 is disposed at a position where the first guard 71A receives the liquid shaken off outward from the substrate W. Accordingly, the residue removing liquid 97 flows into the same guard as film pieces of the processing film 300 peeled off by the peeling gas, and the residue removing liquid 97 flows the film pieces to the drainage system 200 through the first drain piping 60A while dissolving the film pieces of the peeled processing film 300. That is, the residue removing step 274 is one example of a “film piece discharge step” of guiding the film pieces of the processing film 300 to the drain piping 60 by the residue removing liquid 97 (DIW) which is one example of the “first liquid.” The guard 71, etc. is one example of the “film piece discharge portion.”

The substrate processing method also includes, after the residue removing step 274, as shown in FIG. 12E, a replacement step 275 of replacing the residue removing liquid 97 on the substrate W with a replacement liquid 98 (organic solvent, for example, IPA) which is one example of the “second liquid.” Specifically, the replacement liquid 98 (IPA) is supplied to the principal surface Wf of the substrate W to which the residue removing liquid 97 adheres, and the residue removing liquid 97 (DIW) is replaced with the replacement liquid 98 (IPA) and eliminated from the substrate W.

In the replacement step 275, the replacement liquid valve 258 is opened, and the replacement liquid 98 (IPA) is ejected from the second moving nozzle 10 toward the upper surface of the substrate W. The ejected replacement liquid 98 (IPA) receives a centrifugal force on the substrate W and spreads over the entire region of the principal surface Wf. The replacement liquid 98 (IPA) replaces the residue removing liquid 97 (DIW) remaining on the principal surface Wf of the substrate W and eliminates the residue removing liquid to the outside of the substrate W. For example, a paddle step may be performed in which the replacement liquid 98 is ejected from the second moving nozzle 10 to the center of the upper surface of the substrate W while the substrate W is held and rotated (the rotational speed is, for example, about 800 rpm) by the spin chuck 5, and after the replacement liquid 98 spreads over the entire region of the principal surface Wf, the rotation of the substrate W is decelerated or stopped to hold a liquid film of the replacement liquid 98 on the substrate W. It is preferable to perform the paddle step for a time sufficient for the replacement liquid 98 to replace the residue removing liquid 97 on the substrate W. Thereafter, by rotating the substrate W by the spin chuck 5, the replacement liquid 98 can be eliminated to the outside of the substrate W.

In the replacement step 275, for example, the guard 71 may be disposed at a position where the second guard 71B receives liquid shaken off outward from the substrate W. Accordingly, in the replacement step 275, the replacement liquid 98 (IPA) discharged from the substrate W is received by the second guard 71B and guided to the second drain piping 60B.

The substrate processing method also includes, as illustrated in FIG. 12F, after the replacement step 275, a drying step 276 (typically a spin drying step) for shaking off and drying the liquid on the surface of the substrate W. The replacement liquid 98 (IPA) on the surface of the substrate W is eliminated to the outside of the substrate W by a centrifugal force, and disappears from the surface of the substrate W by volatilization into the atmosphere. As in the replacement step 275, the guard 71 may be disposed at a position where the second guard 71B receives the liquid shaken off outward from the substrate W.

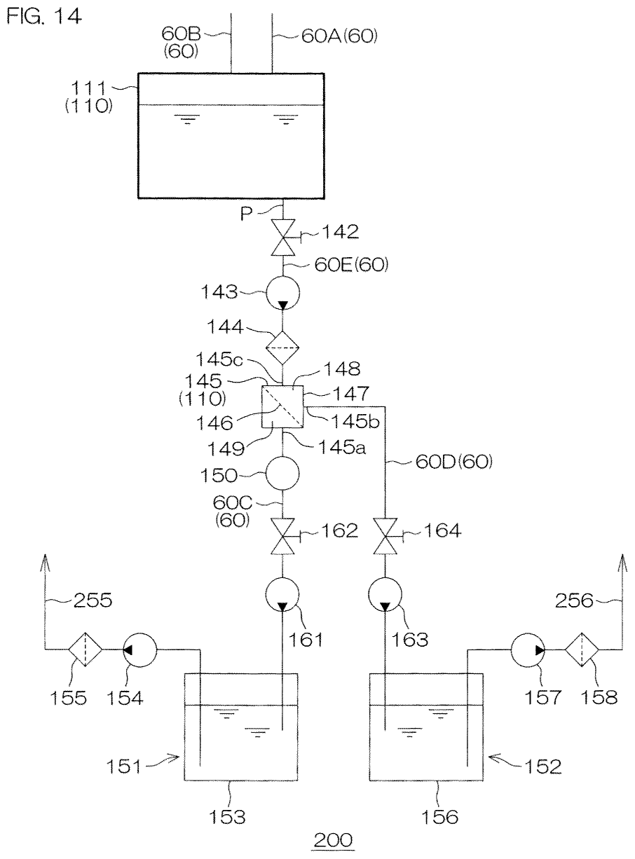

FIG. 14 shows a configuration example of the drainage system 200 in this preferred embodiment. In FIG. 14, the same reference numerals are given to corresponding parts to the portions illustrated in FIG. 6A, etc., and description thereof is simplified.

The drainage system 200 includes a drain piping 60, a separator 110 provided in the drain piping, a first liquid storage 151, and a second liquid storage 152. The drain piping 60 includes a first drain piping 60A that guides a waste liquid received by the first guard 71A and a second drain piping 60B that guides the waste liquid received by the second guard 71B.

The separator 110 is connected to the first drain piping 60A and the second drain piping 60B, and includes a waste liquid trap tank 111 that commonly houses and stores the waste liquid from the first drain piping 60A and the second drain piping 60B. In the residue removing step 274 (see FIG. 12D), the residue removing liquid (DIW) is received by the first guard 71A, and the film pieces of the processing film 300 previously received by the first guard 71A in the peeling step 273 (see FIG. 10C) are dissolved by the residue removing liquid. The residue removing liquid flows into the waste liquid trap tank 111 through the first drain piping 60A together with the film pieces of the processing film 300 while dissolving the film pieces. In the waste liquid trap tank 111, the dissolution of the film pieces of the processing film 300 by the residue removing liquid (DIW) further proceeds (film piece dissolving step). In the replacement step 275 (see FIG. 12E), the replacement liquid (organic solvent, IPA) is received by the second guard 71B, and flows into the waste liquid trap tank 111 through the second drain piping 60B. Therefore, the residue removing liquid (DIW) and the replacement liquid (organic solvent, IPA) are mixed in the waste liquid trap tank 111.

In this example, since the processing film 300 is water-soluble, it is dissolved by a residue removing liquid (DIW). On the other hand, since the processing film 300 is insoluble or poorly soluble in the replacement liquid (IPA), it is preferable to separate and remove replacement liquid (IPA) in order to reuse the residue removing liquid (DIW). However, since DIW and IPA are compatible with each other, the above-described configuration examples of FIGS. 6A to 8B are not necessarily suitable for separation thereof. The configuration example using the ion exchange resin unit 140 illustrated in FIG. 9 can possibly be applied by appropriately selecting the ion exchange resin column 141 capable of separating DIW and IPA.

In this preferred embodiment, the separator 110 separates DIW and IPA using a separation membrane 146 (dehydration membrane) through which water can permeate but IPA cannot permeate. The separation membrane 146 may be a polymer membrane made of a polymer material, an inorganic membrane made of an inorganic material, or a membrane other than these. A specific example of the separation membrane 146 is a zeolite membrane made of zeolite.

More specifically, in this configuration example, the separator 110 includes a dehydrator 145 connected to the discharge port P through a fifth drain piping 60E (drain piping 60). A valve 142, a pump 143, and a filter 144 are interposed in the fifth drain piping 60E.

The dehydrator 145 includes the separation membrane 146 that separates water from IPA, and a dehydration housing 147 that houses the separation membrane 146. The dehydration housing 147 includes a concentration chamber 148 and a permeation chamber 149 partitioned from each other by the separation membrane 146. The permeation chamber 149 is a chamber located in a flow path on the downstream side with respect to the separation membrane 146, and guides the liquid that has permeated the separation membrane 146 to the third drain piping 60C. On the other hand, the concentration chamber 148 is a chamber located in a flow path on the upstream side with respect to the separation membrane 146, and guides the liquid that does not permeate the separation membrane 146 to the fourth drain piping 60D. That is, the third drain piping 60C is connected to a first outlet port 145a communicating with the permeation chamber 149, and the fourth drain piping 60D is connected to a second outlet port 145b communicating with the concentration chamber 148. The third drain piping 60C is provided with a vacuum pump 150 for decompressing the permeation chamber 149.

The valve 142, the pump 143, the vacuum pump 150, and other elements are controlled by the controller 3 (see FIG. 10).

When the pump 143 is operated in a state where the valve 142 is opened, the liquid (the mixed liquid containing DIW and IPA) in the waste liquid trap tank 111 is discharged from the discharge port P to the fifth drain piping 60E, and after foreign matters (particles, etc.) are removed by the filter 144, the liquid is introduced into the concentration chamber 148 from an introduction port 145c of the dehydrator 145. In the dehydrator 145, DIW permeates through the separation membrane 146 and is guided to the permeation chamber 149 due to a pressure difference between the concentration chamber 148 and the permeation chamber 149. On the other hand, IPA does not permeate through the separation membrane 146 and remains in the concentration chamber 148. Accordingly, DIW is guided from the first outlet port 145a to the first liquid storage 151 through the third drain piping 60C, and IPA is guided from the second outlet port 145b to the second liquid storage 152 through the fourth drain piping 60D. In this way, DIW and IPA can be separated (separation step 277 in FIG. 11) and collected in the first liquid storage 151 and the second liquid storage 152, respectively (collecting step 278 in FIG. 11).

Although the DIW collected in the first liquid storage 151 contains the dissolved product of the processing film 300, there is no problem even if the DIW is reused as the residue removing liquid in the residue removing step 274 (see FIG. 12D). Since the IPA collected in the second liquid storage 152 is sufficiently dehydrated in the dehydrator 145, the IPA can be reused as the replacement liquid in the replacement step 275 (see FIG. 12E) without any problem.

Therefore, the residue removing liquid piping 255 is connected to the first tank 153 of the first liquid storage 151, and the pump 154 and the filter 155 are interposed in the residue removing liquid piping 255. When the pump 154 is driven, DIW stored in the first tank 153 is pumped out, foreign matters (particles) are removed by the filter 155, and then it is supplied to the second moving nozzle 10 through the residue removing liquid valve 257 (see also FIG. 10).

Similarly, the replacement liquid piping 256 is connected to the second tank 156 of the second liquid storage 152, and the pump 157 and the filter 158 are interposed in the replacement liquid piping 256. When the pump 157 is driven, IPA stored in the second tank 156 is pumped out, foreign matters (particles) are removed by the filter 158, and then it is supplied to the second moving nozzle 10 through the replacement liquid valve 258 (see also FIG. 10).

### <Example of Processing Liquid>

Hereinafter, one example of each component in the processing liquid used in the preferred embodiment described above will be described.

In the following, entries such as “Cx˜y,” “Cx˜Cy,” and “Cx” signify the number of carbon atoms in a molecule or a substituent. For example, C1˜6 alkyl signifies an alkyl chain having not less than 1 and not more than 6 carbon atoms (methyl, ethyl, propyl, butyl, pentyl, hexyl, etc.).

When a polymer has more than one type of repeat unit, these repeat units are copolymerized. Unless otherwise specified, the copolymerization may be any of alternating copolymerization, random copolymerization, block copolymerization, graft copolymerization, or a mixture thereof. When a polymer and a resin are expressed by a structural formula, n, m, etc., which are written together in parentheses indicate the number of repetitions.

### <Low Solubility Component (Second Component)>

The low solubility component (A) includes at least one among novolacs, polyhydroxystyrenes, polystyrenes, polyacrylic acid derivatives, polymaleic acid derivatives, polycarbonates, polyvinyl alcohol derivatives, polymethacrylic acid derivatives, and copolymers that are combinations of these. Preferably, the low solubility component (A) may include at least one among novolacs, polyhydroxystyrenes, polyacrylic acid derivatives, polycarbonates, polymethacrylic acid derivatives, and copolymers that are combinations of these. More preferably, the low solubility component (A) may include at least one among novolacs, polyhydroxystyrenes, polycarbonates, and copolymers that are combinations of these. The novolac may be a phenol novolac.

The processing liquid may contain one or a combination of two or more of the preferred examples mentioned above as the low solubility component (A). For example, the low solubility component (A) may include both a novolac and a polyhydroxystyrene.

As a preferred mode, the low solubility component (A) becomes a film upon being dried and the film is peeled off by the peeling liquid without a large portion thereof becoming dissolved and while holding the removal object. A mode where a very small portion of the low solubility component (A) is dissolved by the peeling liquid is allowable.

The low solubility component (A) preferably does not contain fluorine and/or silicon and more preferably contains neither.

Preferably, the copolymerization is random copolymerization or block copolymerization.

With no intention to limit the scope of claims, the respective compounds represented by Chemical Formulae 1 to 7 indicated below can be cited as specific examples of the low solubility component (A).

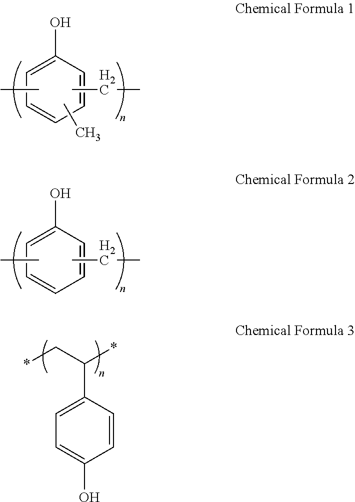

(The asterisk * indicates bonding to a neighboring constituent unit.)

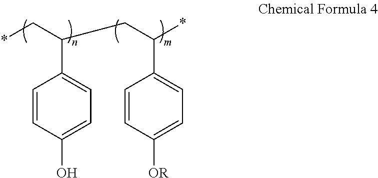

(R denotes a substituent such as a C₁₋₄ alkyl, etc. The asterisk * indicates bonding to a neighboring constituent unit.)

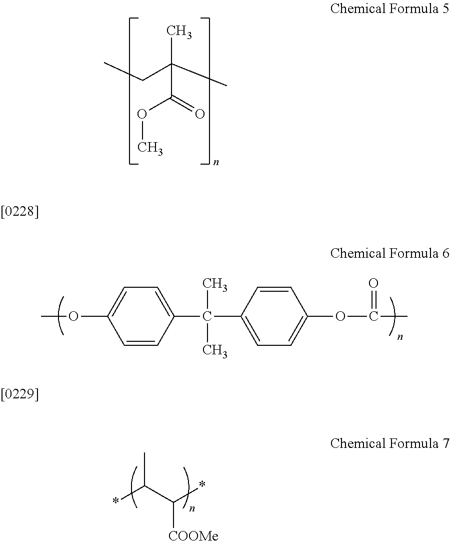

(Me denotes a methyl group. The asterisk * indicates bonding to a neighboring constituent unit.)

A weight average molecular weight (Mw) of the low solubility component (A) is preferably 150˜500, 000, more preferably 300˜300,000, even more preferably 500˜100, 000, and yet even more preferably 1,000˜50,000.

The low solubility component (A) can be acquired by synthesizing. It is also commercially available. In the case of purchase, the following can be cited as examples of suppliers. It is also possible for a supplier to synthesize the polymer (A).
Novolac: Showa Kasei Co., Ltd., Asahi Yukizai Corporation, Gun Ei Chemical Industry Co., Ltd., Sumitomo Bakelite Co., Ltd.;
Polyhydroxystyrene: Nippon Soda Co., Ltd., Maruzen Petrochemical Co., Ltd., TOHO Chemical Industry Co., Ltd.; Polyacrylic acid derivative: Nippon Shokubai Co., Ltd.; Polycarbonate: Sigma-Aldrich Co. LLC;
Polymethacrylic acid derivative: Sigma-Aldrich Co. LLC.

Compared to the total mass of the processing liquid, the amount of the low solubility component (A) is 0.1˜50 mass %, preferably 0.5˜30 mass %, more preferably 1˜20 mass %, and still more preferably 1˜10 mass %. In other words, on basis of the total mass of the processing liquid as 100 mass %, the amount of the low solubility component (A) is 0.1˜50 mass %. That is, “compared to” can be interchangeable with “on basis of.” Unless noted otherwise, the same applies hereinafter.

### <High Solubility Component (First Component)>

The high solubility component (B) is a crack promoting component (B′). The crack promoting component (B′) contains a hydrocarbon and further contains a hydroxy group (—OH) and/or carbonyl group (—C(═O)—). If the crack promoting component (B′) is a polymer, one type of constituent unit contains a hydrocarbon and further has a hydroxy group and/or carbonyl group in each unit. As the carbonyl group, carboxylic acid (—COOH), aldehyde, ketone, ester, amide, and enone can be cited, and carboxylic acid is preferable.

Although not intended to restrict the scope of rights and not bound by theory, it is believed that when, upon drying of the processing liquid and forming of the processing film on the substrate, the peeling liquid peels off the processing film, the high solubility component (B) gives rise to portions that start the peeling off of the processing film. It is thus preferable for the high solubility component (B) to be higher in solubility in the peeling liquid than the low solubility component (A). As a mode in which the crack promoting component (B′) contains ketone as the carbonyl group, an annular hydrocarbon can be cited. As specific examples, 1, 2-cyclohexanedione and 1, 3-cyclohexanedione can be cited.

As a more specific mode, the high solubility component (B) is represented by at least one among (B-1), (B-2), and (B-3) indicated below. (B-1) is a compound that contains 1˜6 (preferably 1˜4) of Chemical Formula 8 indicated below as a constituent unit and with which each constituent unit is bonded by a linking group (linker L1). Here, the linker L1 may be a single bond or a C1˜6 alkylene. The C1˜6 alkylene links the constituent units as a linker and is not restricted to a divalent group. Preferably, it is of a valency of 2˜4. The C1˜6 alkylene may either be a straight chain or be branched.

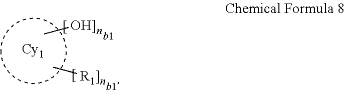

Cy1 is a hydrocarbon ring of C5˜30 and is preferably phenyl, cyclohexane, or naphthyl and more preferably phenyl. As a preferable mode, the linker L1 links a plurality of Cy1's.

R₁ is each independently C_{1˜5} alkyl and is preferably methyl, ethyl, propyl, or butyl. The C_{1˜5} alkyl may either be a straight chain or be branched.

nb1 is 1, 2, or 3 and is preferably 1 or 2 and more preferably 1. nb1′ is 0, 1, 2, 3, or 4 and is preferably 0, 1, or 2.

Chemical Formula 9 indicated below is a chemical formula with which the constituent unit described by Chemical Formula 8 is represented using a linker L9. The linker L9 is preferably a single bond, methylene, ethylene, or propylene.

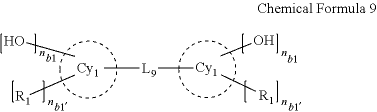

With no intention to limit the scope of claims, 2, 2-bis(4-hydroxyphenyl) propane, 2,2′-methylenebis(4-methylphenol), 2, 6-bis [(2-hydroxy-5-methylphenyl)methyl]-4-methylphenol, 1, 3-cyclohexanediol, 4,4′-dihydroxybiphenyl, 2, 6-naphthalenediol, 2, 5-Di-tert-butylhydroquinone, and 1, 1, 2, 2-tetrakis (4-hydroxyphenyl) ethane can be cited as preferred examples of (B-1). These may be obtained by polymerization or condensation.

As an example, 2, 6-bis [(2-hydroxy-5-methylphenyl)methyl]-4-methylphenol represented by Chemical Formula 10 indicated below shall be taken up and described. This compound has three of the constituent units of Chemical Formula 8 in (B-1) and the constituent units are bonded by the linker L1 (methylene). nb1=nb1′=1 and R1 is methyl.

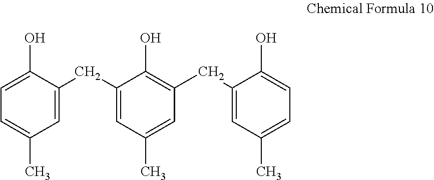 [SMILES: Cc1ccc(O)c(Cc2cc(C)cc(Cc3cc(C)ccc3O)c2O)c1]

(B-2) is represented by Chemical Formula 11 indicated below.

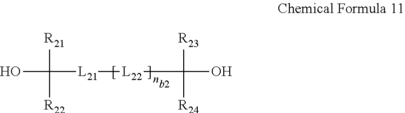

R21, R22, R23, and R24 are each independently hydrogen or C1˜5 alkyl and is preferably hydrogen, methyl, ethyl, t-butyl, or isopropyl, more preferably hydrogen, methyl, or ethyl, and even more preferably methyl or ethyl.

A linker L21 and a linker L22 are each independently C1˜20 alkylene, C1˜20 cycloalkylene, C2˜4 alkenylene, C2˜4 alkynylene, or C6˜20 arylene. These groups may be substituted with C1˜5 alkyl or hydroxy. Here, alkenylene shall mean a divalent hydrocarbon having one or more double bonds and alkynylene shall mean a divalent hydrocarbon group having one or more triple bonds. The linker L21 and the linker L22 are each preferably C2˜4 alkylene, acetylene (C2 alkynylene) or phenylene, more preferably C2˜4 alkylene or acetylene, and even more preferably acetylene.

nb2 is 0, 1 or 2, preferably 0 or 1, and more preferably 0.

With no intention to limit the scope of claims, 3, 6-dimethyl-4-octyne-3, 6-diol and 2, 5-dimethyl-3-hexyne-2, 5-diol can be cited as preferred examples of (B-2). As another mode, 3-hexyne-2, 5-diol, 1,4-butynediol, 2,4-hexadiyne-1,6-diol, 1,4-butanediol, cis-1, 4-dihydroxy-2-butene, and 1, 4-benzenedimethanol can also be cited as preferred examples of (B-2).

(B-3) is a polymer that contains constituent units represented by Chemical Formula 12 indicated below and has a weight average molecular weight (Mw) of 500˜10,000. The Mw is preferably 600˜5, 000 and more preferably 700˜3,000.

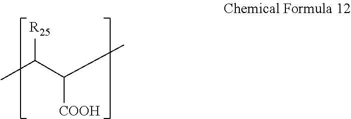

Here, R25 is —H, —CH3, or —COOH, and preferably —H or —COOH. It is also allowable for one polymer (B-3) to contain two or more types of constituent units that are each represented by Chemical Formula 12.

With no intention to limit the scope of claims, a polymer of acrylic acid, maleic acid, or a combination of these can be cited as a preferred example of the polymer (B-3). Polyacrylic acids and maleic acid/acrylic acid copolymers are more preferred examples.

In the case of copolymerization, random copolymerization or block copolymerization is preferable, and random copolymerization is more preferable.

As an example, a maleic acid acrylic acid copolymer represented by Chemical Formula 13 indicated below shall be taken up and described. This copolymer has two types of constituent units that are contained in (B-3) and represented by Chemical Formula 12 with R25 in one of the constituent units being-H and R25 in the other of the constituent units being-COOH.

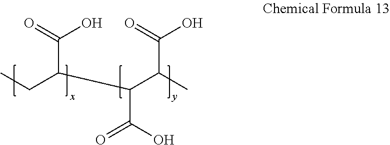

Needless to say, the processing liquid may have one or two or more of the preferred examples mentioned above contained in combination as the high solubility component (B). For example, the high solubility component (B) may contain both 2, 2-bis(4-hydroxyphenyl) propane and 3, 6-dimethyl-4-octyne-3, 6-diol.

The high solubility component (B) may have a molecular weight of 80˜10,000. The high solubility component preferably has a molecular weight of 90˜5000 and more preferably 100˜3000. If the high solubility component (B) is a resin, a polymerized body, or a polymer, the molecular weight is expressed by a weight average molecular weight (Mw).

The high solubility component (B) can be acquired by synthesizing or purchasing. As suppliers, Sigma-Aldrich Co. LLC, Tokyo Chemical Industry Co., Ltd., and Nippon Shokubai Co., Ltd. can be cited.

In the processing liquid, the high solubility component (B), compared to a mass of the low solubility component (A), is preferably of 1˜100 mass % and more preferably of 1˜50 mass %. In the processing liquid, the high solubility component (B), compared to the mass of the low solubility component (A), is even more preferably of 1˜30 mass %.

### <Solvent>

A solvent (C) may be water (particularly in the case of the preferred embodiment shown in FIG. 10, etc.), or an organic solvent may be a main component. The solvent (C) may have volatility. Having volatility means that the solvent is high in volatility as compared to water. For example, a boiling point of the solvent (C) at 1 atm is preferably 50˜250° C. The boiling point of the solvent at 1 atm is more preferably 50˜200° C. and even more preferably 60˜170° C. The boiling point of the solvent at 1 atm is yet even more preferably 70˜150° C. It is permissible for the solvent (C) to contain a small amount of pure water when it is an organic solvent. The pure water contained in the solvent (C) is preferably not more than 30 mass % as compared to the entire solvent (C). The pure water contained in the solvent (C) is more preferably of not more than 20 mass % and even more preferably of not more than 10 mass %. The pure water contained in the solvent (C) is yet even more preferably not more than 5 mass %. The solvent not containing pure water (0 mass %) is also a preferred mode. The pure water is preferably DIW.

Examples of the organic solvent include alcohols, such as isopropanol (IPA); ethylene glycol monoalkyl ethers, such as ethylene glycol monomethyl ether and ethylene glycol monoethyl ether; ethylene glycol monoalkyl ether acetates, such as ethylene glycol monomethyl ether acetate and ethylene glycol monoethyl ether acetate; propylene glycol monoalkyl ethers, such as propylene glycol monomethyl ether (PGME) and propylene glycol monoethyl ether (PGEE); propylene glycol monoalkyl ether acetates, such as propylene glycol monomethyl ether acetate (PGMEA) and propylene glycol monoethyl ether acetate; lactic acid esters, such as methyl lactate and ethyl lactate (EL); aromatic hydrocarbons, such as toluene and xylene; ketones, such as methyl ethyl ketone, 2-heptanone, and cyclohexanone; amides, such as N, N-dimethylacetamide and N-methylpyrrolidone; and lactones, such as γ-butyrolactone. These organic solvents can be used alone or two or more types can be mixed and used.

As a preferred mode, the organic solvent contained in the solvent (C) is selected from IPA, PGME, PGEE, EL, PGMEA, and any combination thereof. When the organic solvent is a combination of two types, the volume ratio thereof is preferably 20:80˜80:20, and more preferably 30:70˜70:30.

The amount of the solvent (C) is 0.1˜99.9 mass % as compared to the total mass of the processing liquid. Compared to the total mass of the processing liquid, the amount of the solvent (C) is preferably 50˜99.9 mass % and more preferably 75˜99.5 mass %. Compared to the total mass of the processing liquid, the solvent (C) is even more preferably of 80˜99 mass % and yet even more preferably of 85˜99 mass %.

### <Other Additives>

The processing liquid may further contain other additives (D). Examples of other additives (D) include surfactants, acids, bases, antimicrobials, bactericides, preservatives, or antifungals (preferably surfactant), and may include any combination thereof.

Compared to the mass of the low solubility component (A) in the processing liquid, the amount of the other additives (D) (if more than one, the sum) is 0˜100 mass % (preferably 0˜10 mass %, more preferably 0˜5 mass %, still more preferably 0˜3 mass %, and yet still more preferably 0˜1 mass %). The processing liquid does not have to contain other additives (D) (0 mass %).

### <Corrosion Inhibiting Component>

Examples of a corrosion inhibiting component (E) include uric acid, caffeine, butyrin, adenine, glyoxylic acid, glucose, fructose, and mannose besides BTA.

Although preferred embodiments of the present invention have been described above, the present invention may be implemented in yet other modes.

For example, the processing liquid is not limited to those described above. For example, a resist film forming liquid or a reflection film forming liquid can be used as the processing liquid. In this case, a developer can be used as the peeling liquid.

As the processing liquid, it is also possible to use a water-soluble polymer-containing liquid that forms a water-soluble film by evaporating a solvent (particularly in the case of the preferred embodiment shown in FIG. 10, etc.).

The water-soluble polymer contains, for example, at least one of cellulose-based polymers such as hydroxypropylmethylcellulose phthalate, hydroxypropylmethylcellulose acetate phthalate, hydroxypropylmethylcellulose acetate succinate, hydroxypropylmethylcellulose hexahydrophthalate, hydroxypropylmethylcellulose, hydroxypropylcellulose, hydroxyethylcellulose, cellulose acetate hexahydrophthalate, carboxymethylcellulose, ethylcellulose and methylcellulose; acryl-based polymers such as N, N-dimethylacrylamide, dimethylaminopropylmethacrylamide, N, N-dimethylaminopropylacrylamide, N-methylacrylamide, diacetone acrylamide, dimethylaminoethylmethacrylate, diethylaminoethylmethacrylate, N, N-dimethylaminoethylacrylate, acryloylmorpholine and acrylic acid; and vinyl-based polymers such as polyvinyl alcohol and polyvinylpyrrolidone. These water-soluble polymers may be used singly or in combination of two or more kinds thereof.

In the preferred embodiment described above, an example in which the “second liquid” is supplied to the substrate has been described; however, the “second liquid” may be guided to the drain piping without being supplied to the substrate. For example, a dissolving liquid for dissolving the film pieces of the processing film in the drain piping 60 may be supplied to the drain piping 60 from the vicinity of the guard 71. Further, a liquid for flowing and moving the film pieces of the processing film to the waste liquid trap tank or the like may be supplied from, for example, the vicinity of the guard 71.

In the preferred embodiment described above, an example of the single substrate processing type substrate processing apparatus has been described, but the present invention is also applicable to a batch type substrate processing apparatus that collectively processes a plurality of substrates.

In this specification, when a numerical range is indicated using “˜” or “-,” unless restrictedly mentioned otherwise, both endpoints are included and the units are the same.

While preferred embodiments of the present invention have been described in detail, these are merely specific examples used to clarify the technical content of the present invention and the present invention should not be interpreted as being limited to these specific examples and the scope of the present invention are to be limited only by the appended claims.

What is claimed is:

1. A substrate processing apparatus, comprising:
a spin chuck to hold a substrate;
a processing liquid nozzle to supply a processing liquid containing a solute and a solvent to a surface of the substrate held by the spin chuck;
a processing film forming portion including a spin motor to rotate the spin chuck, configured to solidify or cure the processing liquid to form a processing film on the surface of the substrate;
a peeling portion including a fluid nozzle to supply a fluid toward the surface of the substrate held by the spin chuck, configured to peel off the processing film from the surface of the substrate;
a drain piping to discharge a waste liquid discharged from the substrate held by the spin chuck;
a film piece discharge portion including a guard disposed around the spin chuck, configured to guide film pieces of the processing film that have been peeled off from the surface of the substrate by the peeling portion and discharged from the surface of the substrate to the drain piping using a first liquid;
a second liquid supplying portion including a second liquid nozzle to eject a second liquid different from the first liquid, configured to supply the second liquid to the drain piping;
a separator provided in the drain piping, configured to separate the first liquid and the second liquid;
a first liquid storage to receive the first liquid separated by the separator; and
a second liquid storage to receive the second liquid separated by the separator,
wherein the processing film is soluble in one of the first liquid and the second liquid, and is insoluble or poorly soluble in the other of the first liquid and the second liquid.

2. The substrate processing apparatus according to claim 1, wherein the second liquid nozzle supplies the second liquid to the substrate in the spin chuck.

3. The substrate processing apparatus according to claim 1, wherein
the processing film is insoluble or poorly soluble in the first liquid and soluble in the second liquid,
the fluid nozzle includes a peeling liquid nozzle to eject a peeling liquid as the fluid, and the peeling portion is configured to peel off the processing film from the surface of the substrate by supplying the first liquid as the peeling liquid from the peeling liquid nozzle to the surface of the substrate in the spin chuck, and
the guard of the film piece discharge portion is configured to guide the peeling liquid discharged from the surface of the substrate together with the film pieces of the processing film to the drain piping.

4. The substrate processing apparatus according to claim 3, wherein
the second liquid nozzle includes a residue removing liquid nozzle to eject a residue removing liquid as the second liquid, the second liquid supplying portion includes a residue removing processing portion configured to supply the residue removing liquid to the surface of the substrate from the residue removing liquid nozzle in the spin chuck, and dissolve and remove a residue of the processing film remaining on the surface of the substrate from which the processing film has been peeled off by the peeling portion, and
the residue removing liquid discharged from the surface of the substrate is guided to the drain piping.

5. The substrate processing apparatus according to claim 1, wherein
the processing film is soluble in the first liquid and insoluble or poorly soluble in the second liquid,
the film piece discharge portion includes a residue removing liquid nozzle to supply the first liquid as a residue removing liquid to the surface of the substrate in the spin chuck and dissolve a residue of the processing film remaining on the surface of the substrate from which the processing film has been peeled off by the peeling portion, and is configured to guide the residue removing liquid discharged from the surface of the substrate together with the film pieces of the processing film to the drain piping, and
the second liquid nozzle includes a replacement liquid nozzle to eject a replacement liquid as the second liquid,
the second liquid supplying portion includes a replacement processing portion configured to supply the replacement liquid from the replacement liquid nozzle to the surface of the substrate in the spin chuck and replace the residue removing liquid remaining on the surface of the substrate with the replacement liquid, and
the second liquid discharged from the surface of the substrate is guided to the drain piping.

6. The substrate processing apparatus according to claim 1, wherein
the fluid nozzle includes a peeling gas nozzle to eject a peeling gas as the fluid, and the peeling portion is configured to peel off the processing film from the surface of the substrate by blowing the peeling gas from the peeling gas nozzle toward the surface of the substrate in the spin chuck.

7. The substrate processing apparatus according to claim 1, wherein
the first liquid and the second liquid are incompatible with each other and have different densities, and
the separator includes:
a waste liquid trap tank to store the first liquid and the second liquid to dissolve film pieces of the processing film;
a first discharge port to discharge the first liquid from the waste liquid trap tank;
a second discharge port to discharge the second liquid from the waste liquid trap tank; and
a valve mechanism having a floating body that vertically moves following an interface between the first liquid and the second liquid in the waste liquid trap tank, configured to open one of the first discharge port and the second discharge port and close the other of the first discharge port and the second discharge port by the vertical movement of the floating body.

8. The substrate processing apparatus according to claim 1, wherein
the first liquid and the second liquid are incompatible with each other, and have different densities and different melting points,
the separator includes:
a waste liquid trap tank to store the first liquid and the second liquid to dissolve film pieces of the processing film;
a chiller to freeze one of a first liquid layer and a second liquid layer formed by vertically separating the first liquid and the second liquid in the waste liquid trap tank to transition to a solid phase, and to maintain the other of the first liquid layer and the second liquid layer in a liquid phase; and
a liquid phase discharge piping to discharge the other of the first liquid layer and the second liquid layer, which is maintained in the liquid phase while the one of the first liquid layer and the second liquid layer is in a solid phase, from the waste liquid trap tank.

9. The substrate processing apparatus according to claim 1, wherein the separator includes an ion exchange resin column to selectively extract the first liquid or the second liquid from a mixed liquid of the first liquid and the second liquid.

10. The substrate processing apparatus according to claim 1, wherein
either the first liquid or the second liquid contains water, and
the separator includes a dehydrator to extract water from a mixed liquid of the first liquid and the second liquid.

11. The substrate processing apparatus according to claim 9, further comprising:
a waste liquid trap tank, provided in the drain piping, to store the first liquid and the second liquid, and dissolve film pieces of the processing film,
wherein a mixed liquid of the first liquid and the second liquid is supplied from the waste liquid trap tank to the separator.

12. A substrate processing method, comprising:
supplying a processing liquid containing a solute and a solvent to a surface of a substrate in a spin chuck;
solidifying or curing the processing liquid in the spin chuck to form a processing film on the surface of the substrate;
peeling off the processing film from the surface of the substrate in the spin chuck;
guiding film pieces of the processing film peeled off from the surface of the substrate from the spin chuck to a drain piping using a first liquid and discharging the film pieces;
supplying a second liquid different from the first liquid to the drain piping;
separating the first liquid and the second liquid by a separator provided in the drain piping; and
collecting the first liquid and the second liquid separated by the separator in a first liquid storage and a second liquid storage, respectively,
wherein the processing film is soluble in one of the first liquid and the second liquid, and is insoluble or poorly soluble in the other of the first liquid and the second liquid.

13. The substrate processing method according to claim 12, wherein
the processing film is insoluble or poorly soluble in the first liquid and soluble in the second liquid,
the processing film is peeled off from the surface of the substrate by supplying the first liquid as a peeling liquid to the surface of the substrate in the spin chuck, and
when discharging the film pieces, the peeling liquid discharged from the surface of the substrate together with the film pieces of the processing film is guided to the drain piping.

14. The substrate processing method according to claim 13, further comprising:
when supplying the second liquid, supplying the second liquid as a residue removing liquid to the surface of the substrate in the spin chuck and dissolving and removing a residue of the processing film remaining on the surface of the substrate from which the processing film has been peeled off,
wherein the residue removing liquid discharged from the surface of the substrate is guided to the drain piping.

15. The substrate processing method according to claim 12, wherein
the processing film is soluble in the first liquid and insoluble or poorly soluble in the second liquid,
the method further includes, when discharging the film pieces, supplying the first liquid as a residue removing liquid to the surface of the substrate in the spin chuck and dissolving a residue of the processing film remaining on the surface of the substrate from which the processing film has been peeled off,
the residue removing liquid discharged from the surface of the substrate together with the film pieces of the processing film is guided to the drain piping,
the method further includes, when supplying the second liquid, supplying the second liquid to the surface of the substrate in the spin chuck and replacing the residue removing liquid remaining on the surface of the substrate with the second liquid, and
the second liquid discharged from the surface of the substrate is guided to the drain piping.

16. The substrate processing method according to claim 15, further comprising:
when peeling off the processing film, peeling off the processing film from the surface of the substrate by blowing gas toward the surface of the substrate in the spin chuck.

17. The substrate processing method according to claim 12, wherein
the first liquid and the second liquid are incompatible with each other and have different densities, and
the separator includes:
a waste liquid trap tank to store the first liquid and the second liquid to dissolve film pieces of the processing film;
a first discharge port to discharge the first liquid from the waste liquid trap tank;
a second discharge port to discharge the second liquid from the waste liquid trap tank; and
a valve mechanism having a floating body that vertically moves following an interface between the first liquid and the second liquid in the waste liquid trap tank, configured to open one of the first discharge port and the second discharge port and close the other of the first discharge port and the second discharge port by the vertical movement of the floating body, and
the method further includes, when separating the first liquid and the second liquid,
dissolving film pieces of the processing film in the waste liquid trap tank;
opening the first discharge port by the valve mechanism to discharge the first liquid from the waste liquid trap tank; and
opening the second discharge port by the valve mechanism to discharge the second liquid from the waste liquid trap tank.

18. The substrate processing method according to claim 12, wherein
the first liquid and the second liquid are incompatible with each other, and have different densities and different melting points,
the separator includes: a waste liquid trap tank to store the first liquid and the second liquid to dissolve film pieces of the processing film; and a chiller to freeze one of a first liquid layer and a second liquid layer formed by vertically separating the first liquid and the second liquid in the waste liquid trap tank to transition to a solid phase, and to maintain the other of the first liquid layer and the second liquid layer in a liquid phase, and
the method further includes, when separating the first liquid and the second liquid,
dissolving film pieces of the processing film in the waste liquid trap tank;
freezing the one of the first liquid layer and the second liquid layer by the chiller to transition to the solid phase and maintaining the other of the first liquid layer and the second liquid layer in the liquid phase;
discharging the other of the first liquid layer and the second liquid layer, which is maintained in the liquid phase while the one of the first liquid layer and the second liquid layer is in the solid phase, from the waste liquid trap tank; and
discharging the other of the first liquid layer and the second liquid layer, then melting the one of the first liquid layer and the second liquid layer to transition to a liquid phase; and
discharging the one of the first liquid layer and the second liquid layer that has transitioned to the liquid phase from the waste liquid trap tank after the melting thereof.

19. The substrate processing method according to claim 12, wherein the separator includes an ion exchange resin column to selectively extract the first liquid or the second liquid from a mixed liquid of the first liquid and the second liquid.

20. The substrate processing method according to claim 12, wherein
either the first liquid or the second liquid contains water, and
the separator includes a dehydrator to extracts water from a mixed liquid of the first liquid and the second liquid.

21. The substrate processing method according to claim 19, further comprising:
storing the first liquid and the second liquid in a waste liquid trap tank provided in the drain piping so as to dissolve film pieces of the processing film,
wherein a mixed liquid of the first liquid and the second liquid is supplied from the waste liquid trap tank to the separator.
